(19) United States
(12) Patent Application Publication
(10) Pub. No.: US 2013/0285465 A1
(43) Pub. Date: Oct. 31, 2013

(54) TRANSMITTER CIRCUIT AND SEMICONDUCTOR INTEGRATED CIRCUIT HAVING THE SAME

(71) Applicant: RENESAS ELECTRONICS CORPORATION, Kawasaki-shi (JP)

(72) Inventors: Koichi TAKEDA, Kanagawa (JP); Shunichi KAERIYAMA, Kanagawa (JP)

(73) Assignee: RENESAS ELECTRONICS CORPORATION, Kawasaki-shi, (JP)

(21) Appl. No.: 13/866,386

(22) Filed: Apr. 19, 2013

(30) Foreign Application Priority Data
Apr. 26, 2012 (JP) 2012-101608

(51) Int. Cl. H01F 38/14

(52) U.S. Cl. CPC H01F 38/14
USPC 307/104

(57) ABSTRACT

A transmitter circuit has transistors each of which is provided between an other end of a primary coil to whose one end a power supply voltage is supplied and either of a power supply voltage terminal and a ground voltage terminal, respectively, and a control circuit for, when causing no current to flow through the primary coil, turning on the one transistor and turning off the other transistor.

### CROSS-REFERENCE TO RELATED APPLICATIONS

The disclosure of Japanese Patent Application No. 2012-101608 filed on Apr. 26, 2012 including the specifications, drawings and abstract is incorporated herein by reference in its entirety.

### BACKGROUND

The present invention relates to a transmitter circuit and a semiconductor integrated circuit having the transmitter circuit, for example, to a transmitter circuit for transferring a signal through an alternating-current coupling element and a semiconductor integrated circuit having the transmitter circuit.

When transferring a signal between multiple semiconductor chips whose power supply voltages are different, in the case where the signal is directly transferred by wiring, breakage of the semiconductor chip or a failure of signal transfer may occur according to a voltage difference that arose in a direct current voltage component of the signal that is transferred. Then, when transferring the signal between multiple semiconductor chips whose power supply voltages are different from one another, it is performed that the semiconductor chips are coupled together with an alternating-current coupling element and only an alternating current signal is transferred. There are a capacitor and a transformer as this alternating-current coupling element.

The transformer is an alternating-current coupling element in which a primary coil and a secondary coil are combined magnetically. When the transformer is used as the alternating-current coupling element, by adjusting a winding ratio of the primary coil and the secondary coil of the transformer, a signal (a received signal) of a suitable voltage amplitude is transferred to a receiving-side semiconductor chip regardless the voltage amplitude of the signal (a transmitted signal) transmitted from a transmitting side semiconductor chip. Therefore, a necessity of adjusting the voltage amplitude of the transmitted signal or the received signal on the semiconductor chip is eliminated by performing communication between the semiconductor chips that operate with different supply voltages through the transformer. In the following explanation, the transformer formed over the semiconductor chip is termed an on-chip transformer according to circumstances.

A related technology is disclosed in S. Kaeriyama, S. Uchida, M. Furumiya, M. Okada, and M. Mizuno, “A 2.5 kV isolation 35 kV/us CMR 250 Mbps 0.13 mA/Mbps digital isolator in standard CMOS with an on-chip small transformer,” 2010 Symposium on VLSI Circuits, Technical Digest of Technical Papers, 2010, pp. 197-198.

An isolator disclosed in S. Kaeriyama, S. Uchida, M. Furumiya, M. Okada, and M. Mizuno, “A 2.5 kV isolation 35 kV/us CMR 250 Mbps 0.13 mA/Mbps digital isolator in standard CMOS with an on-chip small transformer,” 2010 Symposium on VLSI Circuits, Technical Digest of Technical Papers, 2010, pp. 197-198 causes a current to temporarily flow through a primary coil by tuning on transistors provided at one end and an other end of the primary coil, respectively. Thereby, in a secondary coil, an electromotive force (a pulse signal) according to a variation of the current flowing through the primary coil occurs.

### SUMMARY

An isolator disclosed in S. Kaeriyama, S. Uchida, M. Furumiya, M. Okada, and M. Mizuno, “A 2.5 kV isolation 35 kV/us CMR 250 Mbps 0.13 mA/Mbps digital isolator in standard CMOS with an on-chip small transformer,” 2010 Symposium on VLSI Circuits, Technical Digest of Technical Papers, 2010, pp. 197-198 has turned off all transistors provided in a one end (or an other end) of a primary coil when causing no current to flow through the primary coil. That is, this isolator makes the one end or the other end of the primary coil be in an open state (a High-Z state) when causing no current to flow through the primary coil.

Therefore, when a difference voltage (a common mode voltage) between a ground voltage of a transmitting side chip and a ground voltage of a receiving side chip varies largely, a voltage of the one end of the primary coil in the open state will vary largely due to a parasitic capacitance formed between the coils. Because of this, there was a problem that an unintended current flowed through the primary coil, which caused a malfunction.

Other problems and new features will become clear from a description and accompanying drawings of this specification.

According to one aspect of this invention, the transmitter circuit has a first and a second transistors that are provided between the other end of the primary coil whose one end is coupled to a first power supply and the first and a second power supplies, respectively, and a control circuit for, when causing no current to flow through the primary coil, turning on the first transistor and turning off the second transistor.

Moreover, according to another aspect of this invention, the transmitter circuit has the first and the second transistors that are provided between the other end of the primary coil whose one end is coupled to the first power supply and the first and the second power supplies, respectively, and a control circuit for causing an intermediate current to flow through the primary coil by turning on the first and the second transistors.

According to the aspects of this invention, it is possible to provide the transmitter circuit capable of signal transfer that avoids the malfunction.

### BRIEF DESCRIPTION OF THE DRAWINGS

FIG. 1 is a block diagram showing a semiconductor integrated circuit according to a first embodiment;

FIG. 2 is a schematic diagram showing an implementation state of the semiconductor integrated circuit according to the first embodiment;

FIG. 3 is a timing chart showing an operation of the semiconductor integrated circuit according to the first embodiment;

FIG. 4A is a diagram showing an equivalent circuit of a drive circuit according to the first embodiment;

FIG. 4B is a diagram showing an equivalent circuit of a drive circuit according to the first embodiment;

FIG. 4C is a diagram showing an equivalent circuit of a drive circuit according to the first embodiment;

FIG. 5 is a diagram for explaining an effect of the semiconductor integrated circuit according to the first embodiment;

FIG. 6 is a diagram for explaining the effect of the semiconductor integrated circuit according to the first embodiment;

FIG. 7 is a diagram for explaining the effect of the semiconductor integrated circuit according to the first embodiment;

FIG. 8 is a block diagram showing a first configuration example of a receiver circuit according to a second embodiment;

FIG. 9 is a diagram showing a specific configuration example of a positive pulse determination circuit (a negative pulse determination circuit) according to the second embodiment;

FIG. 10 is a block diagram showing a second configuration example of the receiver circuit according to the second embodiment;

FIG. 11 is a block diagram showing a third configuration example of the receiver circuit according to the second embodiment;

FIG. 12 is a diagram showing a concrete example configuration of a positive pulse determination circuit (a negative pulse determination circuit) according to the second embodiment;

FIG. 13 is a diagram showing a configuration example of a transmitter circuit according to a third embodiment;

FIG. 14 is a timing chart showing an operation of a semiconductor integrated circuit according to the third embodiment;

FIG. 15A is a diagram showing an equivalent circuit of a drive circuit according to the third embodiment;

FIG. 15B is a diagram showing an equivalent circuit of a drive circuit according to the third embodiment;

FIG. 15C is a diagram showing an equivalent circuit of a drive circuit according to the third embodiment;

FIG. 15D is a diagram showing an equivalent circuit of a drive circuit according to the third embodiment;

FIG. 15E is a diagram showing an equivalent circuit of a drive circuit according to the third embodiment;

FIG. 16 is a timing chart showing an operation of a semiconductor integrated circuit according to a fourth embodiment;

FIG. 17 is a diagram showing a configuration example of a transmitter circuit according to a fifth embodiment;

FIG. 18 is a timing chart showing an operation of a semiconductor integrated circuit according to the fifth embodiment;

FIG. 19 is a timing chart showing an operation of a semiconductor integrated circuit according to a sixth embodiment;

FIG. 20 is a diagram showing a configuration example of a transmitter circuit according to a seventh embodiment;

FIG. 21 is a timing chart showing an operation of a semiconductor integrated circuit according to the seventh embodiment;

FIG. 22 is a diagram showing a configuration example of a transmitter circuit according to an eighth embodiment;

FIG. 23 is a timing chart showing one example of an operation of the transmitter circuit according to the eighth embodiment;

FIG. 24 is a timing chart showing the one example of the operation of the transmitter circuit according to the eighth embodiment;

FIG. 25 is a schematic diagram showing an implementation state of the semiconductor integrated circuits according to the embodiments 1 to 8;

FIG. 26 is a schematic diagram showing an implementation state of the semiconductor integrated circuits according to the embodiments 1 to 8;

FIG. 27 is a schematic diagram showing an implementation state of the semiconductor integrated circuits according to the embodiments 1 to 8;

FIG. 28 is a schematic diagram showing an implementation state of the semiconductor integrated circuits according to the embodiments 1 to 8;

FIG. 29 is a schematic diagram showing an implementation state of the semiconductor integrated circuits according to the embodiments 1 to 8;

FIG. 30 is a schematic diagram showing an implementation state of the semiconductor integrated circuits according to the embodiments 1 to 8;

FIG. 31 is a schematic diagram showing an implementation state of the semiconductor integrated circuits according to the embodiments 1 to 8;

FIG. 32 is a schematic diagram showing an implementation state of the semiconductor integrated circuits according to the embodiments 1 to 8;

FIG. 33 is a schematic diagram showing an implementation state of the semiconductor integrated circuits according to the embodiments 1 to 8;

FIG. 34 is a schematic diagram showing an implementation state of the semiconductor integrated circuits according to the embodiments 1 to 8;

FIG. 35 is a schematic diagram showing an implementation state of the semiconductor integrated circuits according to the embodiments 1 to 8;

FIG. 36 is a schematic diagram showing an implementation state of the semiconductor integrated circuit according to the embodiments 1 to 8;

FIG. 37 is a diagram showing an inverter device to which the semiconductor integrated circuits according to the embodiments 1 to 8 are applied;

FIG. 38 is a timing chart showing an operation of the inverter device to which the semiconductor integrated circuits according to the embodiments 1 to 8 are applied;

FIG. 39 is a diagram showing a configuration of a related art isolator;

FIG. 40 is a timing chart showing an operation of the related art isolator;

FIG. 41A is a diagram for explaining a problem that may occur in the related art isolator;

FIG. 41B is a diagram for explaining a problem that may occur in the related art isolator;

FIG. 42A is a diagram for explaining a problem that may occur in the related art isolator;

FIG. 42B is a diagram for explaining a problem that may occur in the related art isolator;

FIG. 42C is a diagram for explaining a problem that may occur in the related art isolator;

FIG. 42D is a diagram for explaining a problem that may occur in the related art isolator; and

FIG. 42E is a diagram for explaining a problem that may occur in the related art isolator.

### DETAILED DESCRIPTION

### <Prior Examination by Inventors>

Before explaining embodiments, the present inventors explain contents that were obtained on a prior examination about a related art isolator.

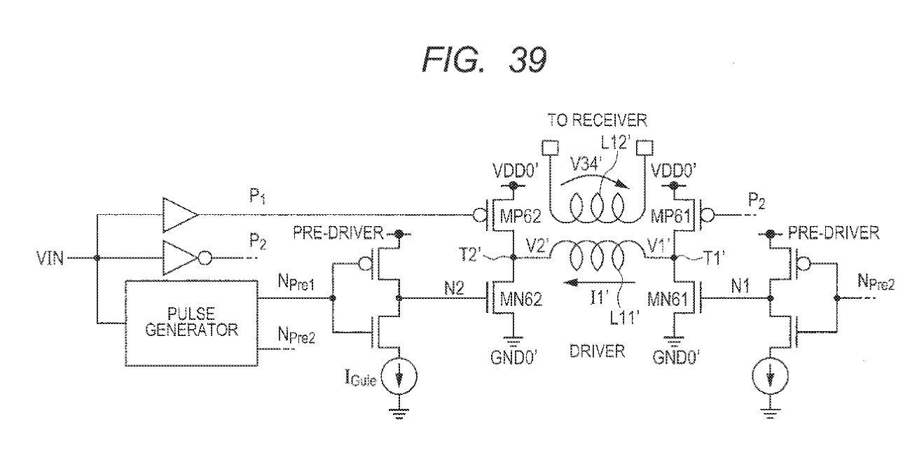

FIG. 39 is a diagram showing a configuration of the isolator disclosed in S. Kaeriyama, S. Uchida, M. Furumiya, M. Okada, and M. Mizuno, “A 2.5 kV isolation 35 kV/us CMR 250 Mbps 0.13 mA/Mbps digital isolator in standard CMOS with an on-chip small transformer,” 2010 Symposium on VLSI Circuits, Technical Digest of Technical Papers, 2010, pp. 197-198. In the isolator shown in FIG. 39, a p-channel MOS transistor (hereinafter, simply termed a transistor) MP61 is provided between a one end T1′ of a primary coil (a transmitting side coil) L11′ and a power supply voltage terminal VDD0′. An re-channel MOS transistor (hereinafter, simply termed a transistor) MN61 is provided between the one end T1′ of the primary coil L11′ and a ground voltage terminal GND0′. Moreover, a p-channel MOS transistor (hereinafter, simply termed a transistor) MP62 is provided between an other end T2′ of the primary coil L11′ and the power supply voltage terminal VDD0′. An n-channel MOS transistor (hereinafter, simply termed a transistor) MN62 is provided between the other end T2′ of the primary coil L11′ and the ground voltage terminal GND0′. Therefore, ON/OFF is complementarily controlled in the transistors MP61, MP62. Furthermore, a pulse generator and two pre-drivers that receive the transmit data VIN and output control signals N1, N2 to respective gates of the transistors MN61, MN62 are provided in the isolator.

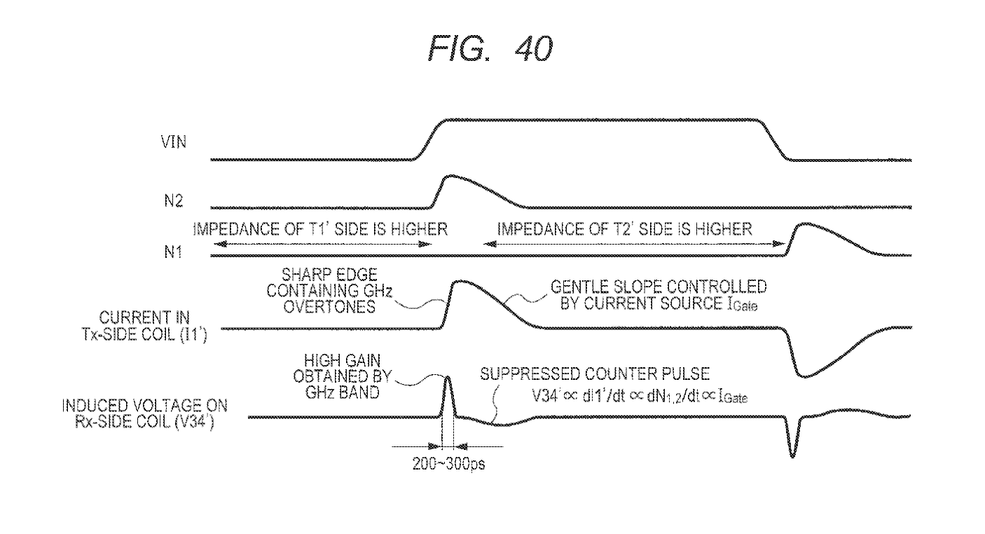

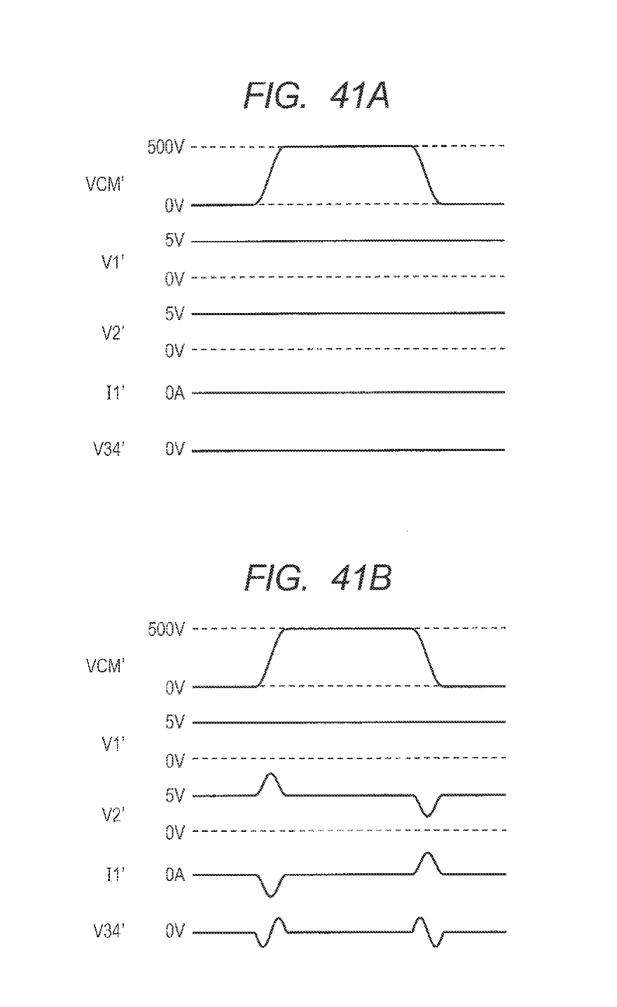

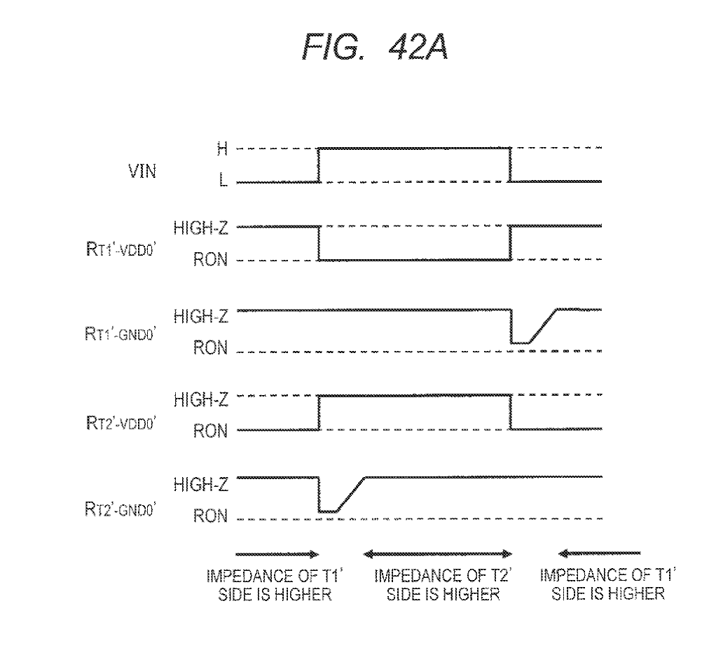

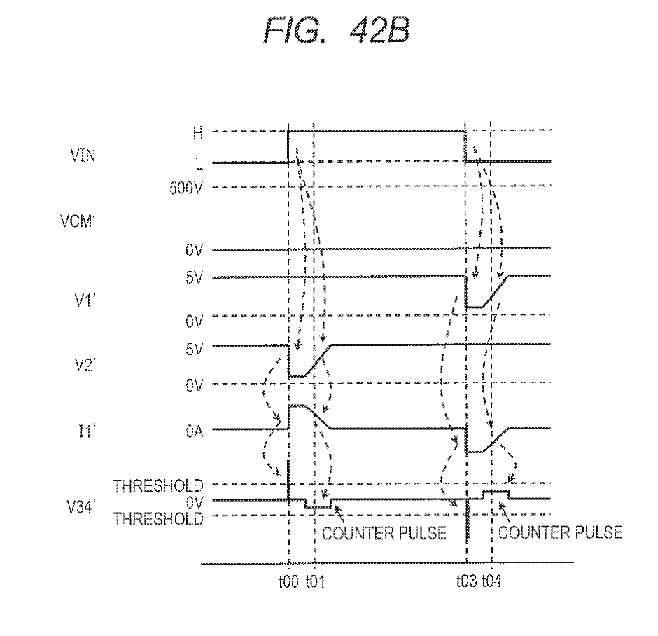

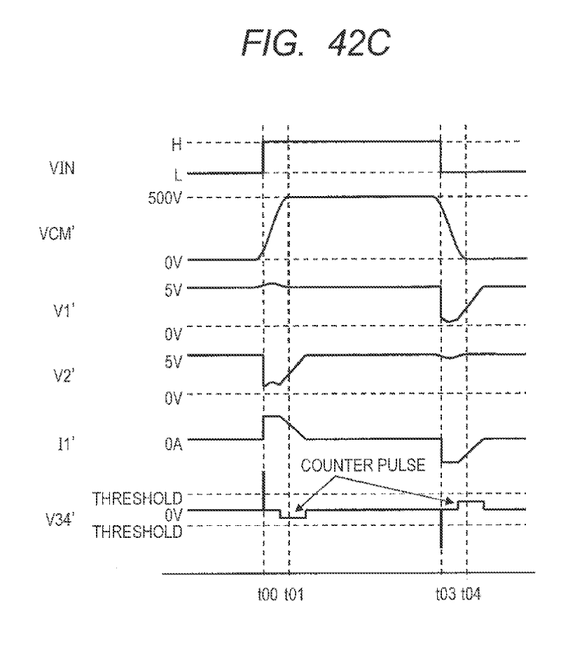

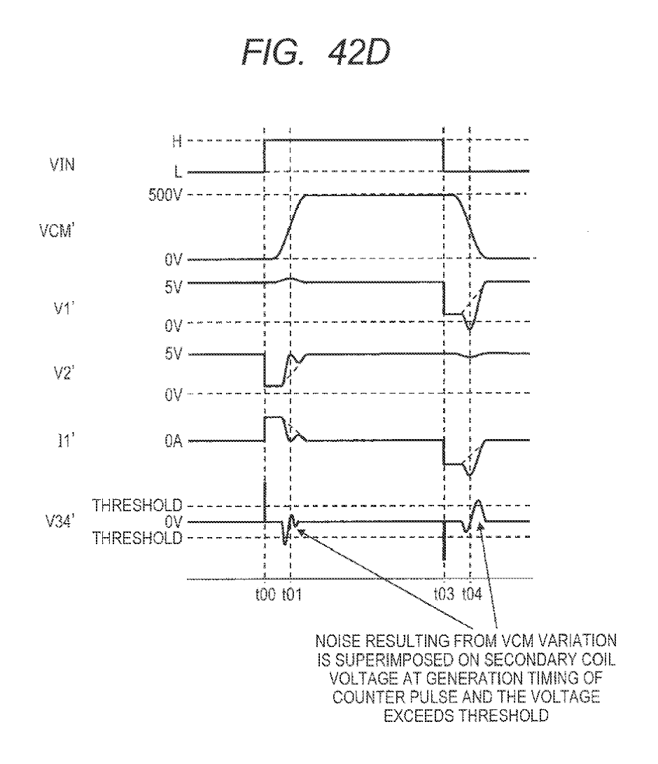

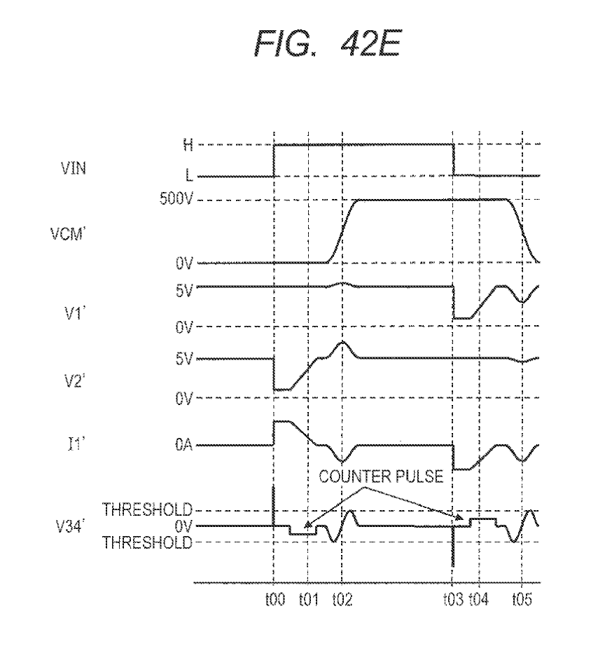

FIG. 40, FIG. 42A, and FIG. 42B are timing charts showing an operation of the isolator shown in FIG. 39. FIG. 40, FIG. 42A, and FIG. 42B show an example of the operation in the case where the transmit data VIN inputted into the isolator shown in FIG. 39 changes sequentially from L level, through H level, to L level. Incidentally, L level shall represent a potential of a low level (Low-level), H level shall represent a potential of a high level (High-level) in this specification, and hereinafter, they are termed L level and H level, respectively.

First, as shown in FIG. 40, the isolator shown in FIG. 39 raises a signal N2 from L level to H level temporarily when the transmit data VIN changes from L level to H level. Subsequently, it reduces the signal N2 gradually to L level. Moreover, when the transmit data VIN changes from H level to L level, it raises a signal N1 temporarily from L level to H level. Subsequently, it reduces the signal N1 gradually to L level.

FIG. 42B shows a voltage V1′ of a terminal T1′ of the primary coil L11′, a voltage V2′ of a terminal T2′, a current I1′ that flows toward the terminal T2′ from the terminal T1′, and a voltage V34′ across the both ends of a secondary coil L12′ when the transmit data VIN is inputted into the isolator shown in FIG. 39 like L level→H level→L level.

As shown in FIG. 40 and FIG. 42B, when the transmit data VIN holds a state of L level, the transistors MP61, MN61, and MN62 turn off and the transistor MP62 turns on. Since the current I1′ does not flow through the primary coil L11′ at this time, the voltage V34′ of the secondary coil (a receiving side coil) L12′ does not vary.

Next, when the transmit data VIN changes from L level to H level (time t00), the transistor MP61 turns on, the signal N2 becomes H level temporarily, the transistor MN62 also turns on, and the transistors MP62, MN61 turn off. Since the terminal T1′ is coupled to the power supply voltage terminal VDD0′ through the transistor MP61, its voltage variation is small. FIG. 42B is described assuming that an ON resistance of the transistor MP61 is nearly zero, so that there exists substantially no voltage variation of a voltage V1′ of the terminal T1′ for simplification of the explanation. On the other hand, since the terminal T2′ is coupled to the ground voltage terminal GND0′ through the transistor MN62, the voltage of the terminal T2′ falls to a level (≅0 V) of a ground voltage GND0′. Therefore, a potential difference of V1′−V2′=VDD0−GND0′ is generated between the terminal T1′ and the terminal T2′. Since this causes the current I1′ to flow toward the other end T2′ from one end T1′ of the primary coil L11′, an electromotive force according to a change of current (dI1′/dt) of the primary coil L11′ occurs in the secondary coil L12′. Thereby, the voltage V34′ of the secondary coil L12′ rises temporarily. That is, a pulse signal of a positive amplitude occurs in the secondary coil L12′.

Subsequently, the transistor MN62 switches from ON to OFF gently by a gentle fall of the signal N2 (time t01). That is, a resistance value of the transistor MN62 rises gently. Thereby, a flow of a current that is flowing toward the other end T2′ from the one end T1′ of the primary coil L11′ stops. Moreover, since the current I1′ starts to decrease with the gentle fall of the signal N2, an electromotive force according to the change of current (dI1′/dt) by this reduction occurs in the secondary coil L12′. The voltage V34′ of the secondary coil falls temporarily. That is, in the secondary coil, a pulse signal (a counter pulse) of a negative amplitude occurs. The isolator shown in FIG. 39 makes an amplitude of the counter pulse small by realizing the gentle fall of the signal N2, and prevents the counter pulse from posing a problem on the receiver circuit side.

When the transmit data VIN holds a state of H level, the transistor MP61 turns on and the transistors MP62, MN61, and MN62 turn off. Since the current I1′ does not flow through the primary coil L11′ at this time, the voltage V34′ of the secondary coil L12′ does not vary.

Next, when the transmit data VIN changes from H level to L level (time t03), the transistor MP62 turns on, the signal N1 becomes H level temporarily, the transistor MN61 turns on, and the transistors MP61, MN62 turn off. Thereby, since the current I1′ flows toward the one end T1′ from the other end T2′ of the primary coil L11′, an electromotive force according to the change of current (dI1′/dt) of the primary coil L11′ occurs in the secondary coil L12′. Thereby, the voltage V34′ of the secondary coil L12′ falls temporarily. That is, the pulse signal of the negative amplitude occurs in the secondary coil L12′.

Subsequently, the transistor MN61 switches from OFF to ON gently by a gentle fall of the signal N1 (time t04). That is, a resistance value of the transistor MN61 rises gently. Thereby, the current that is flowing toward the one end T1′ from the other end T2′ of the primary coil L11′ stops. Incidentally, the counter pulse occurs also in time t04.

FIG. 42A is a diagram showing variations of an impedance between the terminal T1′ of the transmitting side coil L11′ and the power supply voltage terminal VDD0′, an impedance between the terminal T1′ and the ground voltage terminal GND0′, an impedance between the terminal T2′ of the transmitting side coil L11′ and the power supply voltage terminal VDD0′, and an impedance between the terminal T2′ and the ground voltage terminal GND0′. Here, R_{T1′-VDD0′} represents the impedance between the terminal T1′ and the VDD0′, R_{T1′-GND0′} represents the impedance between the terminal T1′ and the GND0′, R_{T2′-VDD0′} represents the impedance between the terminal T2′ and the VDD0′, and R_{T2′-VDD0′} represents the impedance between the terminal T2′ and the GND0′. Therefore, substantially, R_{T1′-VDD0′} is an impedance of the transistor MP61, R_{T1′-GND0′} is an impedance of the transistor MN61, R_{T2′-VDD0′} is an impedance of the transistor MP62, and R_{T2′-VDD0′} is an impedance of the transistor MN62. Therefore, when each transistor is ON, it has an ON resistance value; when it is OFF, it is in High-Z (an open state). Moreover, for convenience of explanation, a synthetic impedance of RT1′-VDD0′ and RT1′-GND0′ is called an impedance of the T1′ side, and a synthetic impedance of RT2′-VDD0′ and RT2′-GND0′ is called an impedance of the T2′ side. Moreover, for simplification of explanation, each of the transistors (MP61, MP62, MN61, and MN62) shall have the same ON resistance (Ron). The resistance value of the ON resistance Ron is described as RON in the figure.

Here, when the transmit data VIN changes from L level to H level, in the isolator shown in FIG. 39, impedances of the both T1′ side and the T2′ side become low. In addition, also when the transmit data VIN changes from H level to L level, the impedances of the both T1′ side and T2′ side become low. On the other hand, when the transmit data VIN holds the state of L level (when causing no current to flow through the primary coil L11′), either of the transistors MP61, MN61 provided on the one side T1′ of the primary coil L11′ is set turned off. That is, the one end T1′ of the primary coil L11′ has become in the open state (a High-Z state). In other words, the impedance of the T1′ side has become high, almost equal to High-Z. Moreover, when the transmit data VIN holds the state of H level (when causing no current to flow through the primary coil L11′), the isolator shown in FIG. 39 turns off the both transistors MP62, MN62 provided on the other end T2′ side of the primary coil L11′. That is, the other end T2′ of the primary coil L11′ has become in the open state (the High-Z state). In other words, the impedance of the T2′ side has become high, almost equal to High-Z.

Therefore, when the difference voltage (a common mode voltage) between the ground voltage GND0′ of a transmitting side chip and the ground voltage of a receiving side chip varies largely, a voltage of one end in the open state among the both ends T17, T2′ of the primary coil will vary largely due to a parasitic capacitance formed between the coils. This variation of the common mode voltage is also called a common mode noise. This variation will cause an unintended current to flow through the primary coil L11′, which may cause a malfunction. Hereinafter, it will be explained in more detail.

FIG. 41A and FIG. 41B are timing charts showing an operation of the related art isolator when the common mode voltage varies. Here, in the circuit shown in FIG. 39, a case where the common mode voltage that is a difference voltage between the ground voltage of a driver for driving the transmitting side coil L11′ (or the transmitting side chip) and the ground voltage of the transmitter circuit having the receiving side coil (or the receiving side chip) varies is considered. FIG. 41A and FIG. 41B show a case illustratively where a variation of the common mode voltage VCM′ is 500 V, the VDD0′ of the transmitting side chip is 5 V, and the GND0′ is 0 V. Incidentally, FIG. 41A shows an ideal operation and FIG. 41B shows an operation that may actually take place. Moreover, FIG. 41A and FIG. 41B explain a case where the other end T2′ of the primary coil L11′ is in the open state (the High-Z state) as an example. Moreover, the V1′ represents a voltage of the one end T1′ of the primary coil L11′ and the V2′ represents a voltage of the other end T2′ of the primary coil L11′.

As shown in FIG. 41A, it is ideally desirable that even when a common mode voltage VCM′ varies, the voltages V1′, V2′ of both ends T1′, T2′ of the primary coil L11′ do not vary. However, as shown in FIG. 41B, in fact, when the common mode voltage VCM′ varies, the voltage V1′ of the terminal T1′ coupled to the power supply voltage terminal VDD0′ hardly varies, but a voltage V2′ of the terminal T2′ in the open state will vary largely by the parasitic capacitance formed between the coils.

Thereby, since it causes a potential difference across the both ends T17, T2′ of the primary coil L11′, the unintended current will flow through the primary coil L11′. Thereby, in the secondary coil L12′, an electromotive force according to the change of current of the primary coil L11′ will occur. That is, an unintended pulse signal will occur in the secondary coil L12′. As a result, it may cause the malfunction. That is, if one terminal of the transmitting side coil is kept in the open state, there is a possibility that a noise by a variation of the difference voltage (the common mode voltage VCM′) between the ground potentials of the transmitter circuit and of the receiver circuit causes the malfunction. Moreover, if the impedance between the one terminal of the transmitting side coil and the ground line or a power supply line is high, the same phenomenon will occur in different degrees.

Following this, an influence of the noise that is caused by this variation of the common mode voltage VCM′ and depends on its generating timing will be considered with reference to FIG. 42C, FIG. 42D, and FIG. 42E. FIG. 42C, FIG. 42D, and FIG. 42E are timing charts showing an operation of the related art isolator when the common mode voltage VCM′ varies. Incidentally, FIG. 42C shows a case where the common mode voltage VCM′ varies simultaneously with the variation of the transmit data VIN, FIG. 42D shows a case where the common mode voltage VCM′ varies at the timing of occurrence of the counter pulse, and FIG. 42E shows a case where the common mode voltage VCM′ varies in an idle state of the isolator (namely, there is no variation of the transmit data VIN), respectively.

First, with reference to FIG. 42C, the case where the common mode voltage VCM′ varies simultaneously with the variation of the transmit data VIN will be considered. In this case, the noise by the variation of the common mode voltage VCM′ occurs around time t00. At this time, the primary coil L11′ is at a timing of having causing the current I1′ to flow and both of the transistors MP61, MN62 become in the ON state. At this time, the terminal T1′ is coupled to the VDD0′, and the terminal T2′ is coupled to the GND0′, each with a low impedance. Therefore, the noise by the variation of the common mode voltage VCM′ is small. Moreover, since the noise by the variation of the common mode voltage VCM′ is due to a coupling capacitance of the primary coil L11′ and the secondary coil L12′, the voltage V1′ of the terminal T1′ and the voltage V2′ of the terminal T2′ vary similarly. Therefore, the potential difference of V1′−V2′ hardly varies, and I1′ and V34′ are hardly affected.

Next, the case where the common mode voltage VCM′ varies at the timing when the counter pulse occurs will be considered with reference to FIG. 42D. In this case, the noise by a variation of the common mode voltage VCM′ occurs around time t01. At this time, the current I1′ is in such a timing that it decreases gradually, and the counter pulse is occurring. Moreover, although the transistor MP61 is ON at this time, since the transistor MN62 is switching from the ON to the OFF state, the impedance of the terminal T2′ side increases gradually. Therefore, the terminal T2′ becomes susceptible to the variation of the common mode voltage VCM′. Then, in the voltage V34′, the original amplitude of the occurring counter pulse is superimposed with the amplitude of the noise by this variation of the common mode voltage VCM′, and therefore misdetermination (malfunction) tends to take place easily.

Next, with reference to FIG. 42E, the case where the common mode voltage VCM′ varies at the timing of the idle state of the isolator (namely, a state where there is no variation of the transmit data VIN) will be considered. In this case, the noise by the variation of the common mode voltage VCM′ occurs around time t02 (during time t01 to time t03). Since the terminal T2′ is almost completely open, only the terminal T2′ becomes susceptible to the variation of the common mode voltage VCM′. Since how the V1′ and the V2′ are affected by an influence of the variation of the common mode voltage VCM′ is different to each other, the variation of common mode voltage VCM′ causes a current to flow, which produces a noise, and thereby the voltage V34′ varies; therefore, the misdetermination (the malfunction) tends to take place easily.

In the above, the case where the transmit data VIN changes from L level to H level was described, but the case where the transmit data VIN changes from H level to L level is also the same.

In short, the noise (the common mode noise) by the variation of common mode voltage VCM′ poses a problem not only when the common mode voltage VCM′ varies at the timing of the idle state (where the terminal T1′ or the terminal T2′ is in the open state) of the isolator, but also when it varies at a timing of occurrence of the counter pulse.

The related art isolator takes into consideration the counter pulse, but does not take into consideration at all the noise by the variation of the common mode voltage VCM′.

Hereinafter, the embodiments will be explained referring to drawings. Incidentally, since the drawings are simplified, technical scopes of the embodiments must not be interpreted narrowly by making description of this drawing into a basis. Moreover, the same reference symbol is given to the same component and its overlapped explanation is omitted.

In the following embodiments, although each of them is divided into multiple sections or multiple embodiments when there is a necessity for convenience, they are not irrelevant to one another except in a case where it is specially specified: one of them has a relationship of being a modification, an application example, a detailed explanation, a supplementary explanation, etc. of part or all of the others. Moreover, when the number of components (including the number of pieces, a numerical value, a quantity, a range, etc.) and the like are referred to in the following embodiments except in a case where it is specially specified, a case where it is clearly limited to a specific number theoretically, etc., it is not limited to that specific number but may be more than or less than the specific number.

Furthermore, in the following embodiments, their components (including operation steps) are not necessarily indispensable except in a case where it is specially specified, a case where it is considered to be clearly indispensable theoretically, etc. Similarly, in the following embodiments, when referring to a shape of a component etc., a positional relationship thereof, and the like, the shape etc. shall include one that is substantially approximate to or similar to that shape etc. except in a case where it is specially specified, a case where it is conceivable that it is clearly not so theoretically, etc. This condition does similarly with respect to the above-mentioned number and the like (including the number of components, a numerical value, a quantity, a range, etc.).

In following explanations of the embodiments, when explaining a circuit operation, the explanation is given taking a case where a variation of a common mode voltage VCM is 500 V and a power supply voltage VDD0 of the transmitting side chip is 5 V, and a ground voltage GND0 is 0 V as an example. Moreover, in the following explanation, the resistance value of the ON resistance Ron is described as RON, and the capacitance value of a capacitive coupling component CC is described as Cc.

### First Embodiment

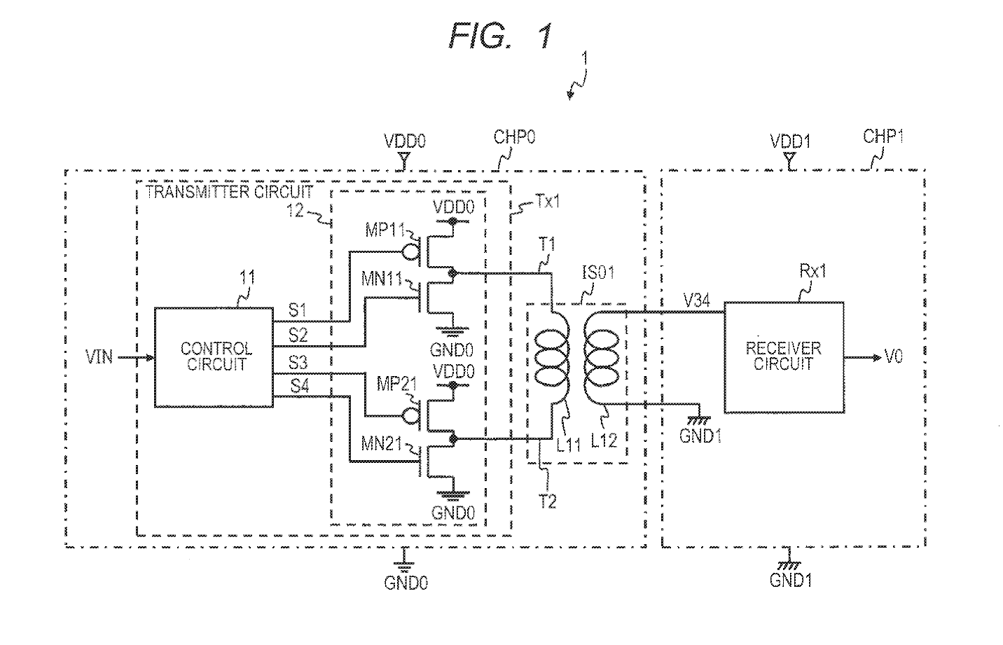

FIG. 1 is a block diagram showing a configuration example of a semiconductor integrated circuit 1 that has a transmitter circuit according to a first embodiment and forms an isolator. The transmitter circuit according to this embodiment couples the both ends of the primary coil and the power supply voltage VDD0 with a comparatively low impedance when causing no current to flow through the primary coil. Thereby, the transmitter circuit according to this embodiment is capable of performing signal transfer accurately (performing malfunction avoiding signal transfer) by controlling the voltage variation of the primary coil even when the common mode voltage VCM varies. Hereinafter, it will be explained specifically.

The semiconductor integrated circuit 1 shown in FIG. 1 has at least a transmitter circuit Tx1, a receiver circuit Rx1, and an alternating-current coupling element ISO1.

The transmitter circuit Tx1 and the alternating-current coupling element ISO1 are formed in a semiconductor chip CHP0. Incidentally, the semiconductor chip CHP0 is driven by the power supply voltage VDD0 supplied from a power supply (a first power supply) and the ground voltage GND0 supplied from a power supply (a second power supply).”

The receiver circuit Rx1 is formed in a semiconductor chip CHP1. Incidentally, the semiconductor chip CHP1 is driven by a power supply voltage VDD1 supplied from a power supply and a ground voltage GND1 supplied from a power supply.

In the below, a case where the alternating-current coupling element ISO1 is an inductor comprised of a primary coil L11 and a secondary coil L12 (hereinafter, referred to simply as a transformer) will be explained as an example, but it is not limited to this. A GMR element etc. may be used as the alternating-current coupling element ISO1. Therefore, this embodiment is applicable not only to an inductor type isolator that uses the inductor for the alternating-current coupling element ISO1 but also to a GMR element type isolator that uses the GMR element.

The transformer is an alternating-current coupling element for transferring an alternating current signal to the secondary coil L12 from the primary coil L11 by converting an electric signal into magnetism with the primary coil L11 and converting the magnetism into an electric signal with the secondary coil L12.

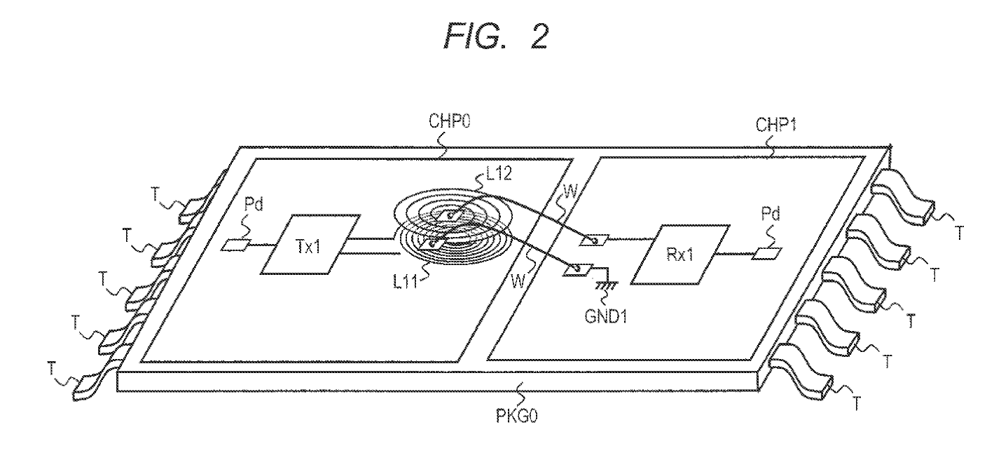

FIG. 2 is a diagram showing one example of an implementation state of the semiconductor integrated circuit 1. Incidentally, FIG. 2 illustrates mainly an implementation state of the transmitter circuit Tx1, the receiver circuit Rx1, and the alternating-current coupling element ISO1 provided therebetween.

In the implementation state shown in FIG. 2, the semiconductor chip CHP0 and the semiconductor chip CHP1 are mounted on a semiconductor package PKG0. The semiconductor chip CHP0 and the semiconductor chip CHP1 have respective pads Pd. Then, each of the pads Pd of the semiconductor chip CHP0 and the semiconductor chip CHP1 is coupled to multiple lead terminals (external terminals) T provided in the semiconductor package PKG0 through bonding wires that are not illustrated.

As shown in FIG. 2, the transmitter circuit Tx1, and the primary coil L11 and the secondary coil L12 that are included in the alternating-current coupling element ISO1 are formed in the semiconductor chip CHP0. The receiver circuit Rx1 is formed in the semiconductor chip CHP1. Furthermore, the pads coupled to both ends of the secondary coil L12, respectively, are formed in the semiconductor chip CHP0. Moreover, the pad coupled to an input of the receiver circuit Rx1 and the pad coupled to the ground voltage terminal GND1 are formed in the semiconductor chip CHP1. Then, the receiver circuit Rx1 is coupled with the secondary coil L12 formed in the semiconductor chip CHP0 through these pads and bonding wires W.

Incidentally, in the example of the implementation state shown in FIG. 2, the primary coil L11 and the secondary coil L12 are formed over a first wiring layer and a second wiring layer that are layered in a vertical direction, respectively, in one semiconductor chip.

Returning to FIG. 1, details of a configuration example of the semiconductor integrated circuit 1 will be explained. Incidentally, as described above, the transmitter circuit Tx1 is driven by the power supply voltage VDD0 and the ground voltage GND0. On the other hand, the receiver circuit Rx1 is driven by the power supply voltage VDD1 and the ground voltage GND1.

The transmitter circuit Tx1 outputs a pulse signal in an amplitude direction according to a transition direction of the transmit data VIN supplied from the outside as a transmitted signal. The transmitter circuit Tx1 has a control circuit 11 and a drive circuit 12. The drive circuit 12 has p-channel MOS transistors (hereinafter, simply termed transistors) MP11, MP21 and n-channel MOS transistors (hereinafter, simply termed transistors) MN11, MN21.

In the transistor (a third transistor) MP11, its source is coupled to a power supply voltage terminal VDD0, its drain is coupled to one end T1 of the primary coil L11, and its gate is supplied with a control signal S1 from the control circuit 11. In the transistor (a fourth transistor) MN11, its source is coupled to a ground voltage terminal GND0, its drain is coupled to a one end T1 of the primary coil L11, and its gate is supplied with a control signal S2 from the control circuit 11. In the transistor (a first transistor) MP21, its source is coupled to the power supply voltage terminal VDD0, its drain is coupled to an other end T2 of the primary coil L11, and its gate is supplied with a control signal S3 from the control circuit 11. In the transistor (a second transistor) MN21, its source is coupled to the ground voltage terminal GND0, its drain is coupled to the other end T2 of the primary coil L11, and its gate is supplied with a control signal S4 from the control circuit 11.

Incidentally, the power supply voltage VDD0 is supplied to the power supply voltage terminal VDD0 from the power supply (the first power supply). The ground voltage GND0 is supplied to the ground voltage terminal GND0 from the power supply (the second power supply).

The control circuit 11 is a circuit that generates the control signals S1 to S4 for controlling ON/OFF of the transistors MP11, MN11, MP21, and MN21 based on the transmit data VIN.

For example, when the transmit data VIN holds the state of L level or H level, the control circuit 11 outputs the control signals S1 to S4 of L level. Thereby, the transistors MP11, MP21 turn on and the transistors MN11, MN21 turn off. At this time, a current I1 does not flow through the primary coil L11

On the other hand, when the transmit data VIN changes from L level to H level, the control circuit 11 continues to output control signals S1, S2 of L level temporarily, and outputs control signals S3, S4 of H level. Thereby, the transistors MP11, MN21 turn on and the transistors MN11, MP21 turn off. At this time, the current I1 (a first current) flows toward the other end T2 from the one end T1 of the primary coil L11. After a lapse of a predetermined time, the control circuit 11 outputs the control signals S1 to S4 of L level.

Moreover, when the transmit data VIN changes from H level to L level, the control circuit 11 outputs the control signals S1, S2 of H level temporarily, and continues to output the control signals S3, S4 of L level. Thereby, the transistors MP11, MN21 turn off and the transistors MN11, MP21 turn on. At this time, the current I1 (a third current) flows toward the one end T1 from the other end T2 of the primary coil L11. After a lapse of a predetermined time, the control circuit 11 outputs the control signals S1 to S4 of L level.

The alternating-current coupling element ISO1 transfers the transmitted signal outputted from the transmitter circuit Tx1 to the receiver circuit Rx1 as the received signal V34. Specifically, the alternating-current coupling element ISO1 generates the received signal V34 of a voltage level according to the change of current of a current flowing through the primary coil L11 in the secondary coil L12.

For example, when the current I1 flows temporarily toward the other end T2 from the one end T1 of the primary coil L11, a positive electromotive force (a pulse signal of the positive amplitude) occurs in the secondary coil L12 as the received signal V34. On the other hand, when the current I1 flows temporarily toward the one end T1 from the other end T2 of the primary coil L11, a negative electromotive force (a pulse signal of the negative amplitude) occurs in the secondary coil L12 as the received signal V34.

The receiver circuit Rx1 reproduces the transmit data VIN based on the received signal V34 from the alternating-current coupling element ISO1, and outputs it as output data VO. Specifically, the receiver circuit Rx1 raises the output data VO in synchronization with the pulse signal of the positive amplitude that occurred in the secondary coil L12, and falls the output data VO in synchronization with the pulse signal of the negative amplitude that occurred in the secondary coil L12.

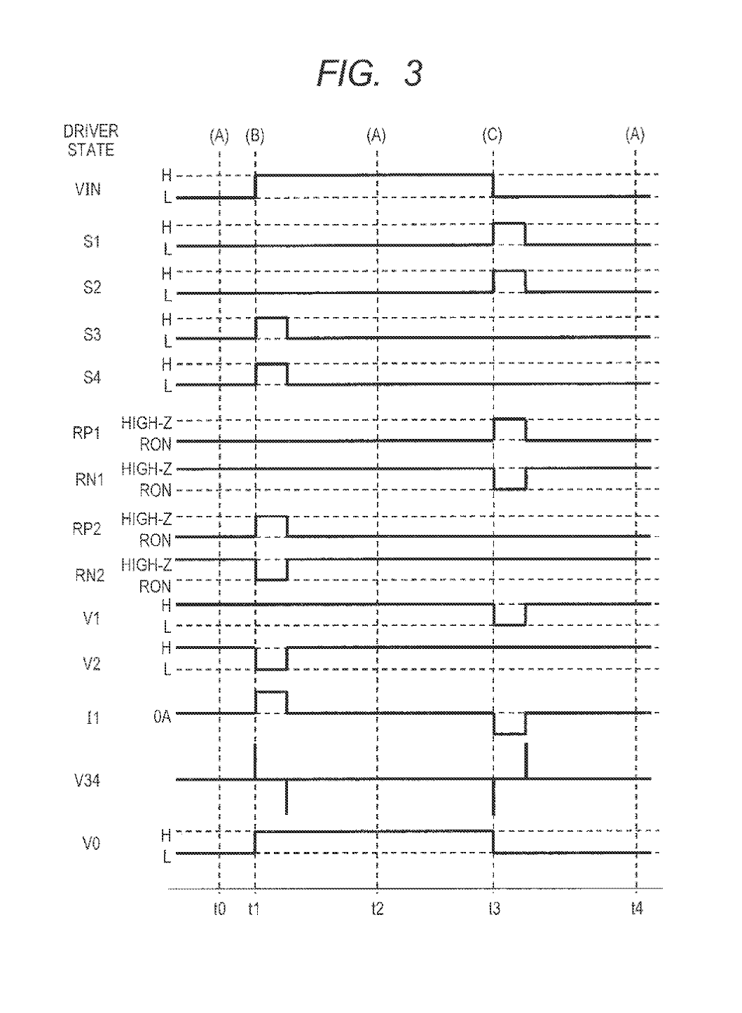

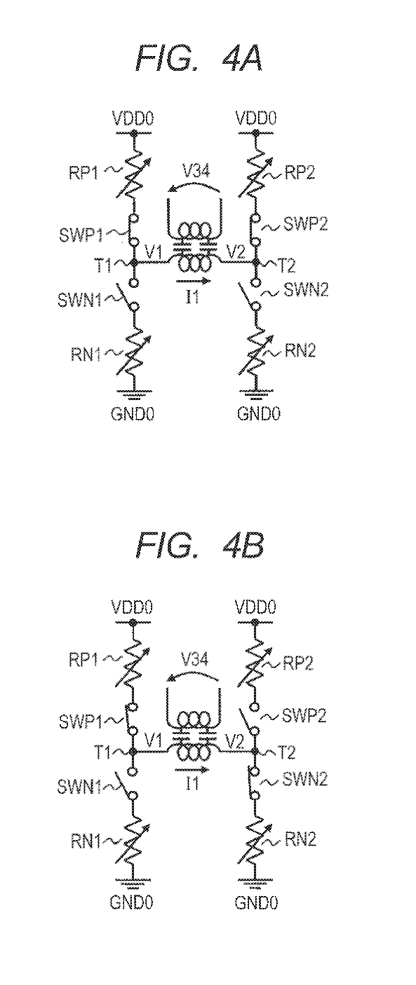

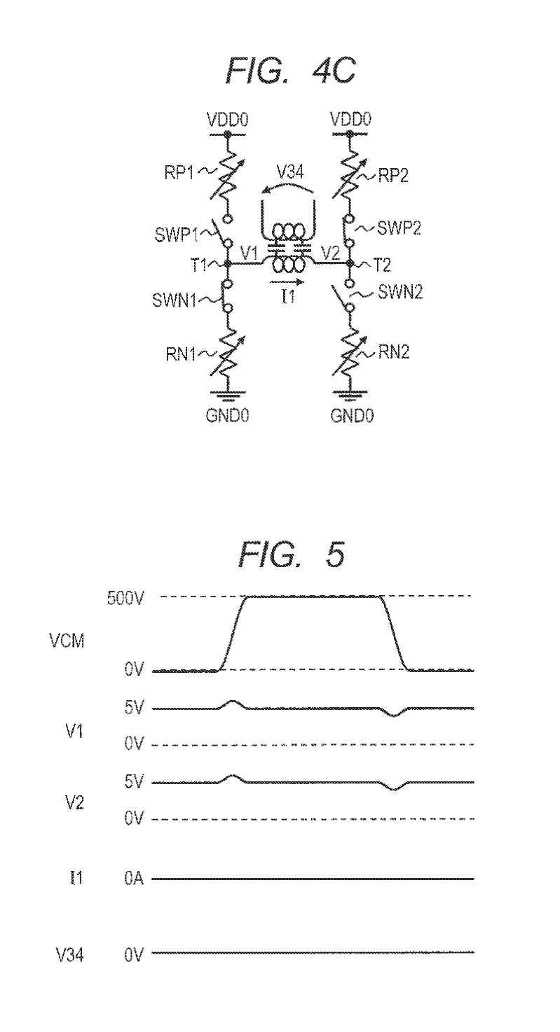

Next, with reference to FIG. 3 and FIG. 4A to FIG. 4C, an operation of the semiconductor integrated circuit 1 shown in FIG. 1 will be explained. FIG. 3 is a timing chart showing the operation of the semiconductor integrated circuit 1. FIG. 4A to FIG. 4C are diagrams each showing an equivalent circuit in each operating state of the drive circuit 12 provided in the transmitter circuit Tx1.

In FIG. 4A to FIG. 4C, a resistive element RP1 and a switching element SWP1 correspond to the transistor MP11, a resistive element RP2 and a switching element SWP2 correspond to the transistor MP21, a resistive element RN1 and a switching device SWN1 correspond to the transistor MN11, and a resistive element RN2 and a switching device SWN2 correspond to the transistor MN21. Incidentally, the resistive element RP1 is one that shows explicitly an impedance between the one end T1 of the primary coil L11 and the power supply voltage terminal VDD0, and the resistive element RN1 is one that shows explicitly an impedance between the one end T1 of the primary coil L11 and the ground voltage terminal GND0, respectively. Similarly, the resistive element RP2 is one that shows explicitly an impedance between the other end T2 of the primary coil L11 and the power supply voltage terminal VDD0, and the resistive element RN2 is one that shows explicitly an impedance between the other end T2 of the primary coil L11 and the ground voltage terminal GND0, respectively. In the following explanation, impedance values of the resistive elements RP1, RN1, RP2, and RN2 are termed impedances RP1, RN1, RP2, and RN2, respectively.

In FIG. 3, the transmit data VIN holds the state of L level in its initial state (time t0). Since the control circuit 11 outputs the control signals S1 to S4 of L level at this time, the transistors MP11, MP21 turn on and the transistors MN11, MN21 turn off (an operating state A shown in FIG. 4A). In other words, the one end T1 of the primary coil L11 is coupled with the power supply voltage terminal VDD0 with a comparatively low impedance RP1 (e.g., 10Ω), and the other end T2 of the primary coil L11 is coupled with the power supply voltage terminal VDD0 with a comparatively low impedance RP2 (e.g., 10Ω). Therefore, the current I1 does not flow through the primary coil L11. Accordingly, the received signal V34 of the secondary coil L12 does not vary.

When the transmit data VIN changes from L level to H level (time t1), the control circuit 11 continues temporarily to output the control signals S1, S2 of L level, and outputs the control signals S3, S4 of H level. Thereby, the transistors MP11, MN21 turn on and the transistors MN11, MP21 turn off (an operating state B shown in FIG. 4B). In other words, the one end T1 of the primary coil L11 is coupled with the power supply voltage terminal VDD0 with a comparatively low impedance RP1, and the other end T2 of the primary coil L11 is coupled with the ground voltage terminal GND0 with a comparatively low impedance RN2 (e.g., 10Ω). Therefore, the current I1 flows toward the other end T2 from the one end T1 of the primary coil L11. Thereby, the pulse signal of the positive amplitude according to the change of current of the primary coil L11 occurs in the secondary coil L12 as the received signal V34. Incidentally, after a lapse of a predetermined time, the control circuit 11 outputs the control signals S1 to S4 of L level.

Next, when the transmit data VIN holds the state of H level (time t2), the control circuit 11 outputs the control signals S1 to S4 of L level. Thereby, the transistors MP11, MP21 turn on and the transistors MN11, MN21 turn off (the operating state A). In other words, the one end T1 of the primary coil L11 is coupled with the power supply voltage terminal VDD0 with a comparatively low impedance RP1, and the other end T2 of the primary coil L11 is coupled with the power supply voltage terminal VDD0 with a comparatively low impedance RP2. Therefore, the current I1 does not flow through the primary coil L11. Therefore, the received signal V34 of the secondary coil L12 does not vary.

When the transmit data VIN changes from H level to L level (time t3), the control circuit 11 outputs temporarily the control signals S1, S2 of H level, and continue to output the control signals S3, S4 of L level. Thereby, the transistors MP11, MN21 turn off and the transistors MN11, MP21 turn on (an operating state C shown in FIG. 4C). In other words, the one end T1 of the primary coil L11 is coupled with the ground voltage terminal GND0 with a comparatively low impedance RN1 (e.g., 10Ω), and the other end T2 of the primary coil L11 is coupled with the power supply voltage terminal VDD0 with a comparatively low impedance RP2. Therefore, the current I1 flows toward the one end T1 from the other end T2 of the primary coil L11. Thereby, in the secondary coil L12, the pulse signal of the negative amplitude according to the change of current of the primary coil L11 occurs as the received signal V34. Incidentally, after a lapse of a predetermined time, the control circuit 11 outputs the control signals S1 to S4 of L level.

Next, when the transmit data VIN holds the state of L level (time t4), the control circuit 11 outputs the control signals S1 to S4 of L level. Thereby, the transistors MP11, MP21 turn on and the transistors MN11, MN21 turn off (the operating state A). In other words, the one end T1 of the primary coil L11 is coupled with the power supply voltage terminal VDD0 with a comparatively low impedance RP1, and the other end T2 of the primary coil L11 is coupled with the power supply voltage terminal VDD0 with a comparatively low impedance RP2. Therefore, the current I1 does not flow through the primary coil L11. Therefore, the received signal V34 of the secondary coil L12 does not vary.

The receiver circuit Rx1 raises the output data VO in synchronization with the pulse signal of the positive amplitude that occurs in the secondary coil L12 (time t1), and falls the output data VO in synchronization with the pulse signal of the negative amplitude that occurs in the secondary coil L12 (time t3).

Thus, when causing no current to flow through the primary coil L11, the transmitter circuit Tx1 couples the both ends T1, T2 of the primary coil L11 and the power supply voltage terminal VDD with each other with a comparatively low impedance (at least an impedance lower than a direct-current resistance (about 100Ω) of the coil) by turning on the transistors MP11, MP21 and turning off the transistors MN11, MN21. Thereby, as shown in FIG. 5, a voltage variation of the primary coil L11 accompanying a variation of the common mode voltage VCM is controlled.

Incidentally, FIG. 5 shows a case where the variation of the difference voltage (the common mode voltage VCM) of the ground voltage (GND0) of the transmitting side chip and the ground voltage (GND1) of the receiving side chip is 500 V. Here, VCM is defined as VCM=GND1−GND0. Moreover, V1 and V2 represent voltages of one end (a terminal T1) and an other end (a terminal T2) of the primary coil L11, respectively, and I1 represents the current flowing through the primary coil L11. Moreover, V34 represents a potential difference between the both ends of the secondary coil L12. In this case, since a one end of the secondary coil L12 is coupled to the ground voltage GND1, the V34 is equivalent to a voltage of the other end side of the secondary coil L12 seen from the GND1. This V34 becomes a received signal level. Incidentally, the voltage level values of VCM, V1, and V2 in FIG. 5 show one example.

That is, the transmitter circuit Tx1 according to this embodiment is capable of performing signal transfer accurately (performing malfunction avoiding signal transfer) by controlling the voltage variation of the primary coil even when the common mode voltage VCM varies.

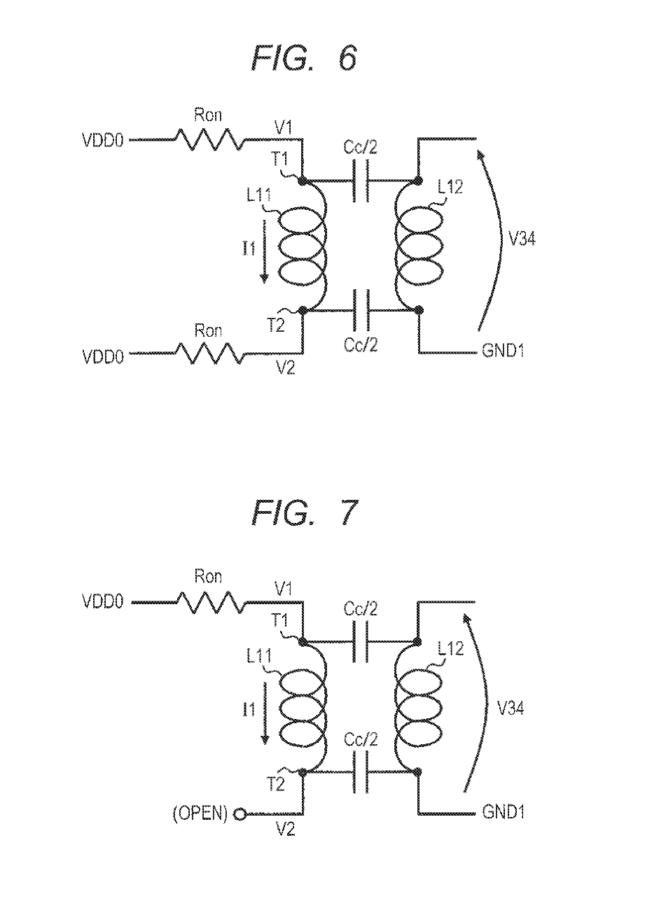

Hereinafter, a variation of a voltage V2 accompanying the variation of the common mode voltage VCM in each of this embodiment and the related art will be explained using FIGS. 6 and 7. Incidentally, here, an attention is paid only to an AC component of a noise that varies under influences of the common mode voltage VCM and the capacitive coupling component (CC) (the noise resulting from by fluctuation of the GND1).

FIG. 6 shows an equivalent circuit of the drive circuit in the transmitter circuit according to this embodiment in a state where the VIN maintains L level or H level. As described above, since the control circuit 11 outputs the control signals S1 to S4 of L level when the VIN is L level, the transistors MP11, MP21 turn on and the transistors MN11, MN21 turn off. Therefore, FIG. 6 shows an equivalent circuit of the drive circuit when the power supply voltage VDD0 is impressed across the both ends T1, T2 of the primary coil L11 through the transistors MP11, MP12 in an ON state. Here, the both transistors MP11, MP21 in the ON state are each approximated as what has the ON resistance Ron. Moreover, since the primary coil L11 and the secondary coil L12 are arranged to be in close proximity to each other, they have a capacity of the parasitic capacitance (CC: capacitive coupling component) formed between the both.

Moreover, in the circuit of FIG. 1, the one end of the secondary coil L12 is grounded to the GND1, and the voltage of the other end is set to the V34. Therefore, the V34 can be regarded as a potential difference to the GND1. That is, the V34 is a potential difference of the both ends of the secondary coil L12, and serves as an output of the secondary coil L12.

First, referring to the equivalent circuit shown in FIG. 6, the voltages V1, V2, and V34 can be expressed by the following formulae: Formula 1, Formula 2, and Formula 3. Incidentally, here, since the attention is paid only to the AC component of the noise that varies under the influences of the common mode voltage VCM and the capacitive coupling component (CC), the voltages V1, V2, and V34 are described as the voltages V1(ω), V2(ω), and V34(ω).

$$\begin{matrix}[ Formula 1 ] & \\ \begin{matrix}V 1 ( ω ) ≅ \frac{Ron}{Ron + ( j ω L 11 + 2 / j ω Cc ) // ( j ω L 12 + 2 / j ω C c )} \cdot GND 1 ( ω ) \\ ≅ \frac{Ron}{Ron + j ω L 11 / 2 + 1 / j ω Cc} \cdot GND 1 ( ω )\end{matrix} \\ ∵ L 11 ≅ L 12 & ( 1 ) \\ [ Formula 2 ] & \\ V 2 ( ω ) ≅ V 1 ( ω ) & ( 2 ) \\ [ Formula 3 ] & \\ V 34 ( ω ) = k \sqrt{\frac{L 12}{L 11}} ( V 1 ( ω ) - V 2 ( ω ) ) ≅ 0 & ( 3 )\end{matrix}$$

As described above, here, Cc represents the capacitance value of the parasitic capacitance formed between the coils (the capacitive coupling component), Ron represents the ON resistance of the transistor, L11 represents the inductance of the primary coil L11, L12 represents the inductance of the secondary coil L12, and k represents a coupling coefficient between the primary coil L11 and the secondary coil L12, respectively. In Formulae (1) to (3), the reference numerals of the primary coil L11 and the secondary coil L12 are substituted for their inductance values, respectively.

Next, a variation of the voltage V2 accompanying the variation of the common mode voltage VCM in the related art will be examined again in detail. FIG. 7 shows an equivalent circuit of the drive circuit in the transmitter circuit shown in FIG. 39 in the state where the VIN maintains L level or H level (a state of no variation of the output). In the related art circuit shown in FIG. 39, one end of the primary coil becomes open in the state of no variation of the output as described above. Here, FIG. 7 shows the drive circuit as an equivalent circuit in the case where it is supposed that the one end of the primary coil shown in FIG. 6 is open for a comparison with FIG. 6. Therefore, parameters and the reference numbers of constitutive members are made the same as those of the constitutive members of FIG. 1. Therefore, in contrast with a related art circuit of FIG. 39, the following correspondences stand: VDD0 is the supply voltage of the primary coil; Ron the ON resistance of a transistor that is ON among MP61 and MP62; L11 the inductance of the primary coil; L12 the inductance of the secondary coil; CC the parasitic capacitance formed between the primary coil and the secondary coil; V1 the voltage of the terminal T2; V2 the voltage of the terminal T1; GND1 the ground voltage of the receiver (receiver circuit); and V34 the potential difference between the both ends of the secondary coil L12. A situation where the V34 is equivalent to the output of the secondary coil L12 is the same as the case of FIG. 6.

Here, referring to the equivalent circuit shown in FIG. 7, the voltages V1, V2, and V34 can be expressed by following Formulae 4, Formula 5, and Formula 6, respectively. Like the case of FIG. 6, here, since the attention is paid only to the AC component of the noise that varies under the influences of the common mode voltage VCM and the capacitive coupling component (CC), the voltages V1, V2, and V34 are described as the voltage V1(ω), V2(ω), and V34(ω).

$$\begin{matrix}[ Formula 4 ] & \\ \begin{matrix}V 1 ( ω ) = \frac{Ron}{Ron + ( j ω L 11 + 2 / j ω Cc ) // ( j ω L 12 + 2 / j ω C c )} \cdot GND 1 ( ω ) \\ ≅ \frac{Ron}{Ron + j ω L 11 / 2 + 1 / j ω Cc} \cdot GND 1 ( ω )\end{matrix} \\ ∵ L 11 ≅ L 12 & ( 4 ) \\ [ Formula 5 ] & \\ \begin{matrix}V 2 ( ω ) = \frac{Ron}{Ron + ( j ω L 11 + 2 / j ω Cc ) // ( j ω L 12 + 2 / j ω C c )} + \\ \frac{( j ω L 11 + 2 / j ω Cc ) // ( j ω L 12 + 2 / j ω C c )}{Ron + ( j ω L 11 + 2 / j ω Cc ) // ( j ω L 12 + 2 / j ω C c )} \times \\ \frac{j ω L 11}{J ω L 11 + 2 / j ω Cc} \\ ≅ \frac{Ron + J ω L 11 / 2}{Ron + j ω L 11 / 2 + 1 / j ω Cc} \cdot GND 1 ( ω )\end{matrix} \\ ∵ L 11 ≅ L 12 & ( 5 ) \\ [ Formula 6 ] & \\ \begin{matrix}V 34 ( ω ) = k \sqrt{\frac{L 12}{L 11}} ( V 1 ( ω ) - V 2 ( ω ) ) \\ ≅ - k \frac{j ω L 11 / 2}{Ron + j ω L 11 + 2 + 1 / j ω Cc} \cdot GND 1 ( ω )\end{matrix} & ( 6 )\end{matrix}$$

As will be understood by comparing Formula 3 and Formula 6, the variation of the voltage V2 accompanying the variation of the common mode voltage VCM can be made smaller in the case where the power supply voltage VDD0 is impressed to the both ends T1, T2 of the primary coil L11 by turning on the switch element than that in an other case. Then, as is clear from the above formulae, in the case of FIG. 6, the voltage V34 accompanying the variation of the common mode voltage VCM can also be made small as compared with that in the case of FIG. 7. Moreover, as shown in FIG. 7, with the related art, if the one terminal of the transmitting side coil is kept in the open state, there is a possibility that a noise caused by a variation of a difference voltage (VCM) between the transmitter circuit and the ground potential occurs, and as a result, the malfunction is caused.

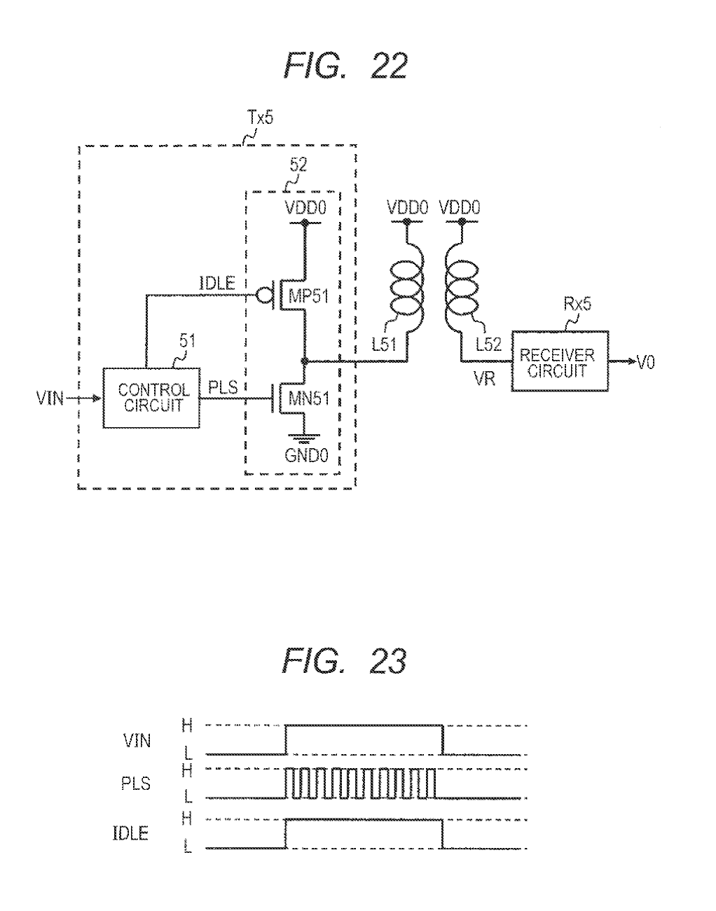

In this embodiment, although the receiver circuit Rx1 is configured so as to raise the output data VO in synchronization with the pulse signal of the positive amplitude that occurs in the secondary coil L12 and to fall the output data VO in synchronization with the pulse signal of the negative amplitude that occurs in the secondary coil L12, in addition to this, a receiver circuit as shown in FIG. 22 may be used. Moreover, in this embodiment, the receiver circuit Rx1 may be configured to be capable of eliminating a pulse signal that occurs in the secondary coil L12 when cutting off the current flowing through the primary coil L11. If such a receiver circuit is used, it will become possible for the receiver circuit Rx1 to eliminate the pulse signal (the counter pulse) that occurs in the secondary coil L12 when cutting off the current flowing through the primary coil L11.

### Second Embodiment

As described above, when the transmit data VIN rises, if the current I1 that are flowing temporarily toward the other end T2 from the one end T1 of the primary coil L11 is cut off, the negative electromotive force (the counter pulse of the negative amplitude) according to the change of current of the primary coil L11 will occur in the secondary coil L12. Similarly, when the transmit data VIN falls, if the current I1 that are flowing temporarily toward the one end T1 from the other end T2 of the primary coil L11 is cut off, a positive electromotive force (a counter pulse of a positive amplitude) according to the change of current of the primary coil L11 will occur in the secondary coil L12. Therefore, if no measure is taken, there will be a possibility that the receiver circuit Rx1 will erroneously take in these counter pulses as regular pulse signals that occur according to variations of the transmit data VIN. That is, without any countermeasure, the receiver circuit Rx1 may perform the misdetermination of a logical value of the data.

Then, the receiver circuit Rx1 adopts a configuration of eliminating these counter pulses. Hereinafter, a specific configuration example of the receiver circuit Rx1 will be explained.

### (First Configuration Example of Receiver Circuit Rx1)

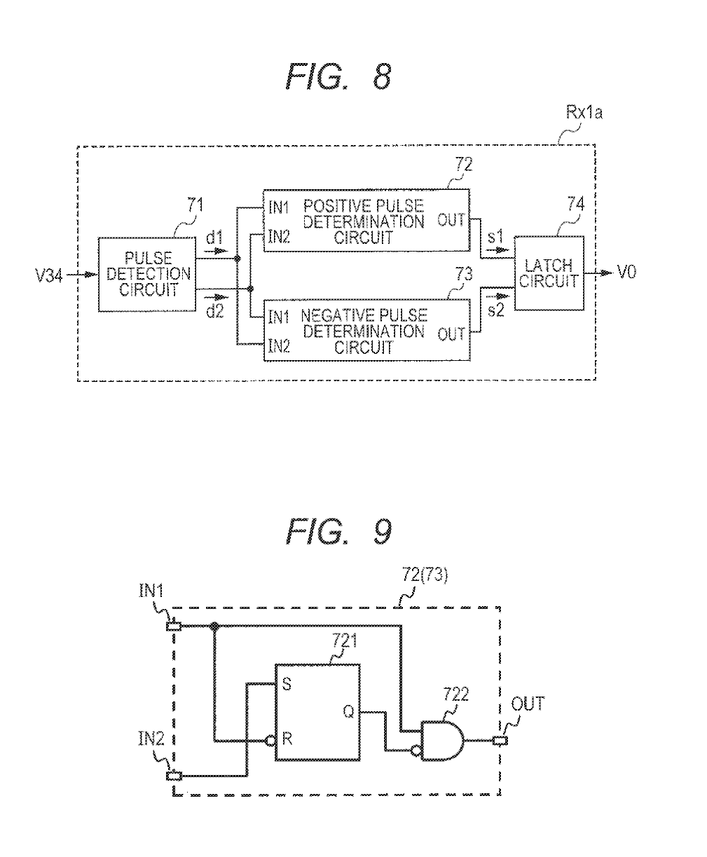

FIG. 8 is a block diagram showing a first configuration example of the receiver circuit Rx1 as a receiver circuit Rx1a. The receiver circuit Rx1a shown in FIG. 8 has a pulse detection circuit 71, a positive pulse determination circuit (a positive pulse determination unit) 72, a negative pulse determination circuit (a negative pulse determination unit) 73, and a latch circuit (a data generation unit) 74.

The pulse detection circuit 71 is a circuit that detects pulse signals of the positive amplitude and of the negative amplitude (a received signal V34) that occur in the secondary coil L12, and outputs them as a detection result (a first detection result) d1 and a detection result (a second detection result) d2, respectively. For example, when a voltage level of the received signal V34 is more than or equal to a threshold voltage Vth+ on a higher level side, the pulse detection circuit 71 detects the pulse signal of the positive amplitude and outputs the detection result d1 of H level during its period. On the other hand, when the voltage level of the received signal V34 is lower than the threshold voltage Vth+ on the higher level side, the pulse detection circuit 71 does not detect the pulse signal of the positive amplitude and outputs the detection result d1 of L level. Similarly, when the voltage level of the received signal V34 is lower than or equal to a threshold voltage Vth− on a lower level side, the pulse detection circuit 71 detects the pulse signal of the negative amplitude and outputs the detection result d2 of H level during its period. On the other hand, when the voltage level of the received signal V34 is higher than the threshold voltage Vth− on the lower level side, the pulse detection circuit 71 does not detect the pulse signal of the negative amplitude and outputs the detection result d2 of L level.

In a period when the both detection results d1, d2 have become L level after the detection result d2 became H level (a first period), the positive pulse determination circuit 72 outputs a determination result (a first determination result) s1 of L level (a first logical value); in other periods, when the detection result d1 is H level, it outputs the determination result (the first determination result) s1 of H level (a second logical value).

In a period when the both detection results d1, d2 have become L level after the detection result d1 became H level (a second period), the negative pulse determination circuit 73 outputs a determination result (a second determination result) s2 of L level (the first logical value); in other periods, when the detection result d2 is H level, it outputs the determination result (the second determination result) s2 of H level (the second logical value).

A latch circuit 74 outputs the output data VO based on the determination result s1 of the positive pulse determination circuit 72 and the determination result s2 of the negative pulse determination circuit 73. The latch circuit 74 is a so-called SR latch circuit. In the latch circuit 74, the determination result s1 is inputted into its set input terminal S, the determination result s2 is inputted into its reset input terminal R, and the output data VO is outputted from its output terminal Q.

Next, specific configurations of the positive pulse determination circuit 72 and the negative pulse determination circuit 73 will be explained. FIG. 9 is a diagram showing one example of the specific configuration of the positive pulse determination circuit 72. The positive pulse determination circuit 72 shown in FIG. 9 has an SR latch circuit 721 and an and circuit (hereinafter, referred to simply as an AND circuit) 722.

In the SR latch circuit 721, a signal of an input terminal IN2 (the detection result d2) is inputted into its set input terminal S, a signal of an input terminal IN1 (the detection result d1) is inputted into its reset input terminal R, and an intermediate signal is outputted from its output terminal Q. An AND circuit 722 outputs an AND (the determination result s1) of a signal of the input terminal IN1 and the intermediate signal from the SR latch circuit 721 to its output terminal OUT.

Since a specific configuration of the negative pulse determination circuit 73 has the same circuit configuration as that of the positive pulse determination circuit 72, its explanation is omitted. However, in the positive pulse determination circuit 72, the detection result d1 is supplied to its input terminal IN1, the detection result d2 is supplied to its input terminal IN2, and the determination result s1 is outputted from its output terminal OUT. On the other hand, in the negative pulse determination circuit 73, the detection result d2 is supplied to its input terminal IN1, the detection result d1 is supplied to its input terminal IN2, and the determination result s2 is outputted from its output terminal OUT.

When the period of detecting the normal pulse signal and the period of detecting the counter pulse overlaps, this circuit configuration enables the receiver circuit Rx1a to eliminate the counter pulse and thereby to receive (reproduce) the data accurately (avoiding the malfunction). At this time, the transmitter circuit Tx1 does not need to fine tune the current that is caused to flow through the primary coil in order to make small the amplitude of the counter pulse. Therefore, increase of power consumption is also controlled.

### (Second Configuration Example of Receiver Circuit Rx1)

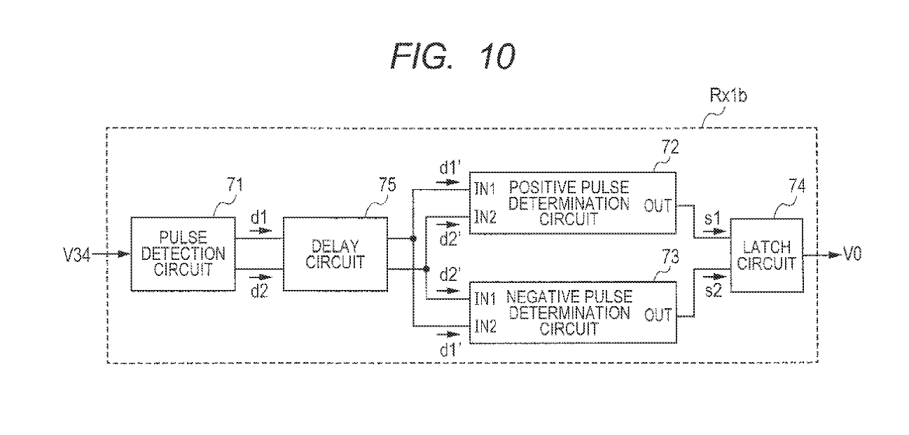

FIG. 10 is a block diagram showing a second configuration example of the receiver circuit Rx1 as a receiver circuit Rx1b. The receiver circuit Rx1b shown in FIG. 10 further has a delay circuit 75 as compared with the receiver circuit Rx1a shown in FIG. 8. Incidentally, the positive pulse determination unit is comprised of the delay circuit 75 and the positive pulse determination circuit 72. The negative pulse determination unit is comprised of the delay circuit 75 and the negative pulse determination circuit 73.

The delay circuit 75 is a circuit that delays falls of the detection results d1, d2 of the pulse detection circuit 71 more greatly than rises thereof and outputs them as detection results d1′, d2′.

The positive pulse determination circuit 72 outputs the determination result s1 based on the detection results d1′, d2′ in place of the detection results d1, d2. Specifically, in the positive pulse determination circuit 72, the detection result d1′ is supplied to its input terminal IN1, the detection result d2′ is supplied to its input terminal IN2, and the determination result s1 is outputted from its output terminal OUT. Thereby, in a period during when both of the detection results d1′, d2′ become L level after the detection result d2′ became H level (the first period), the positive pulse determination circuit 72 outputs the determination result (the first determination result) s1 of L level (the first logical value), and when the detection result d1′ is H level in a period other than the period, outputs the determination result (the first determination result) s1 of H level (the second logical value).

The negative pulse determination circuit 73 outputs the determination result s2 based on the detection results d1′, d2′ in place of the detection results d1, d2. Specifically, in the negative pulse determination circuit 73, the detection result d2′ is supplied to its input terminal IN1, the detection result d1′ is supplied to its input terminal IN2, and the determination result s2 is outputted from its output terminal OUT. Thereby, during a period when the detection result d1′ becomes H level and then both of the detection results d1′ and d2′ become L level (the second period), the negative pulse determination circuit 73 outputs the detection result (the second detection result) s2 of L level (the first logical value), and in a period other than this, when the detection results d2′ is H level, it outputs the determination result (the second determination result) s2 of H level (the second logical value).

Since other circuit configurations of the receiver circuit Rx1b shown in FIG. 10 are the same as those of the receiver circuit Rx1a shown in FIG. 8, their explanations are omitted.

This circuit configuration enables the receiver circuit Rx1b to eliminate the counter pulse and to receive (reproduce) data accurately (avoiding the malfunction) even if the period of detecting the regular pulse signal and the period of detecting the counter pulse do not overlap each other. At this time, the transmitter circuit Tx1 does not need to fine tune the current that is caused to flow through the primary coil in order to make the amplitude of the counter pulse small. Therefore, the increase of the power consumption is also controlled.

### (Third Configuration Example of Receiver Circuit Rx1)

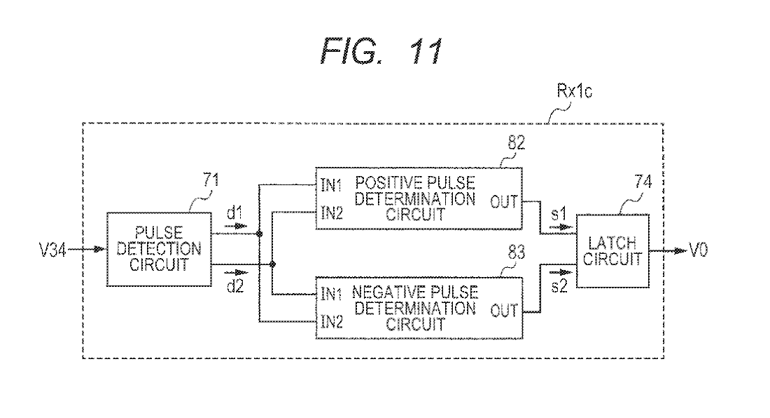

FIG. 11 is a block diagram showing a third configuration example of the receiver circuit Rx1 as a receiver circuit Rx1c. As compared with the receiver circuit Rx1a shown in FIG. 8, the receiver circuit Rx1c shown in FIG. 11 has a positive pulse determination circuit 82 in place of the positive pulse determination circuit 72, and has a negative pulse determination circuit 83 in place of the negative pulse determination circuit 73.

During a predetermined period after the detection result d2 became H level, the positive pulse determination circuit 82 outputs the determination result (the first determination result) s1 of L level (the first logical value), and during a period other than that period, when the detection result d1 is H level, it outputs the determination result (the first determination result) s1 of H level (the second logical value).

During a predetermined period after the detection result d1 became H level, the negative pulse determination circuit 83 outputs the determination result (the second determination result) s2 of L level (the first logical value), and during a period other than that period, when the detection result d2 is H level, it outputs the determination result (the second determination result) s2 of H level (the second logical value).

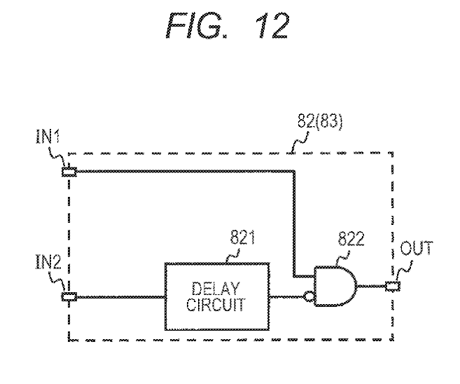

Following this, specific configurations of the positive pulse determination circuit 82 and the negative pulse determination circuit 83 will be explained. FIG. 12 is a diagram showing one example of the specific configuration of the positive pulse determination circuit 82. The positive pulse determination circuit 82 shown in FIG. 12 has a delay circuit 821 and an AND circuit 822.

The delay circuit 821 delays a fall of a signal of the input terminal IN2 (the detection result d2) more than its rise, and outputs it. The AND circuit 822 outputs an AND (the determination result s1) of the signal of the input terminal IN1 (the detection result d1) and an output of the delay circuit 821 to the output terminal OUT.

Since a specific configuration of the negative pulse determination circuit 83 is the same circuit configuration as that of the positive pulse determination circuit 82, its explanation is omitted. However, in the positive pulse determination circuit 82, the detection result d1 is supplied to its input terminal IN1, the detection result d2 is supplied to its input terminal IN2, and the determination result s1 is outputted from its output terminal OUT. On the other hand, in the negative pulse determination circuit 83, the detection result d2 is supplied to its input terminal IN1, the detection result d1 is supplied to its input terminal IN2, and the determination result s2 is outputted from its output terminal OUT.

The circuit configuration like this enables the receiver circuit Rx1c to eliminate the counter pulse that occurs during a predetermined period after detecting a normal pulse signal and to receive (reproduce) data accurately (avoiding the malfunction). At this time, the transmitter circuit Tx1 does not need to fine tune the current that is caused to flow through the primary coil in order to make the amplitude of the counter pulse small. Therefore, the increase of the power consumption is also controlled.

### Third Embodiment

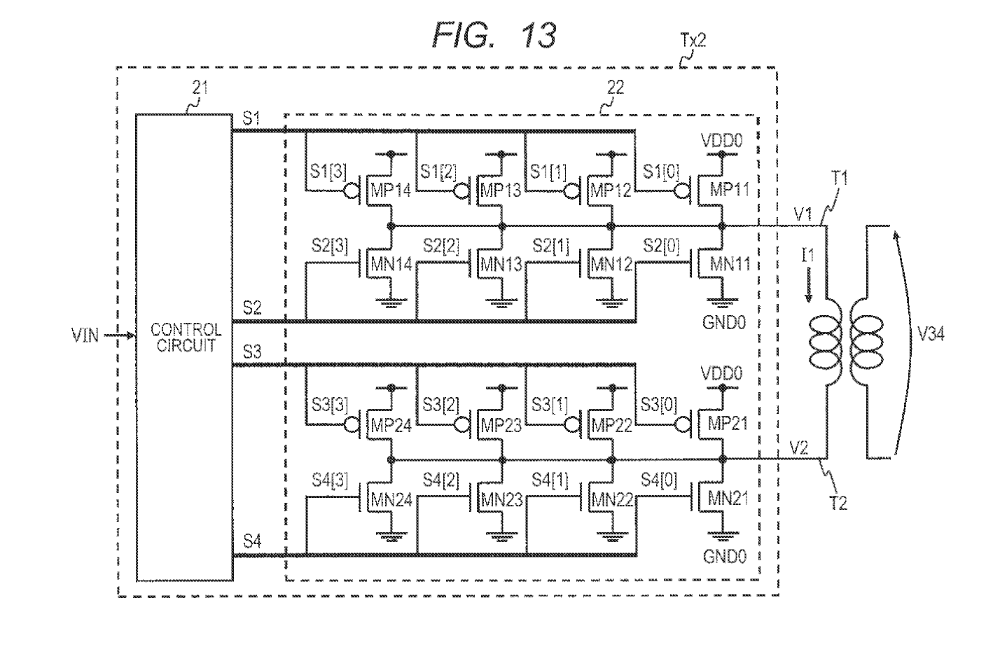

FIG. 13 is a diagram showing a configuration example of a transmitter circuit according to a third embodiment. When cutting off the current I1 flowing through the primary coil L11, a transmitter circuit Tx2 shown in FIG. 13 makes sufficiently small the amplitude of the counter pulse that occurs in the secondary coil L12 by making the current I1 smaller stepwisely. This makes possible highly accurate (malfunction avoiding) signal transfer even if the receiver circuit Rx1 is of a general configuration that does not eliminate the counter pulse. Hereinafter, it will be explained specifically.

Incidentally, the transmitter circuit Tx2 corresponds to the transmitter circuit Tx1 shown in FIG. 1. Moreover, a semiconductor integrated circuit 2 having the transmitter circuit Tx2 corresponds to the semiconductor integrated circuit 1 shown in FIG. 1.

The transmitter circuit Tx2 shown in FIG. 13 has a control circuit 21 and a drive circuit 22. The drive circuit 22 has p-channel MOS transistors (hereinafter, simply termed transistors) MP11 to MP14 and MP21 to MP24, and n-channel MOS transistors (hereinafter, simply termed transistors) MN11 to MN14 and MN21 to MN24.

In each of the transistors (the third transistors) MP11 to MP14, its source is coupled to the power supply voltage terminal VDD0, its drain is coupled to the one end T1 of the primary coil L11, and its gate is supplied with the control signal S1 from the control circuit 11, respectively. More specifically, the control signal S1[0] to S1[3] are supplied to the gates of the transistors MP11 to MP14, respectively. In each of the transistors (the fourth transistors) MN11 to MN14, its source is coupled to the ground voltage terminal GND0, its drain is coupled to the one end T1 of the primary coil L11, and its gate is supplied with the control signal S2 from the control circuit 11, respectively. More specifically, the control signals S2[0] to S2[3] are supplied to the gates of the transistors MN11 to MN14, respectively.

In each of the transistors (the first transistors) MP21 to MP24, its source is coupled to the power supply voltage terminal VDD0, its drain is coupled to the other end T2 of the primary coil L11, and its gate is supplied with the control signal S3 from the control circuit 11, respectively. More specifically, the control signals S3[0] to S3[3] are supplied to the gates of the transistors MP21 to MP24, respectively. In each of the transistors (the second transistors) MN21 to MN24, its source is coupled to the ground voltage terminal GND0, its drain is coupled to the other end T2 of the primary coil L11, and its gate is supplied with the control signal S4 from the control circuit 11, respectively. More specifically, the control signals S4[0] to S4[3] are supplied to the gates of the transistors MN21 to MN24, respectively.

The control circuit 21 is a circuit that generates the control signals S1 to S4 for controlling ON/OFF of the transistors MP11 to MP14, MN11 to MN14, MP21 to MP24, and MN21 to MN24 based on the transmit data VIN.

Since other configurations and operations of the semiconductor integrated circuit 2 are the same as those of the semiconductor integrated circuit 1 shown in FIG. 1, the same reference symbol is given to each of the components and its overlapped explanation is omitted.

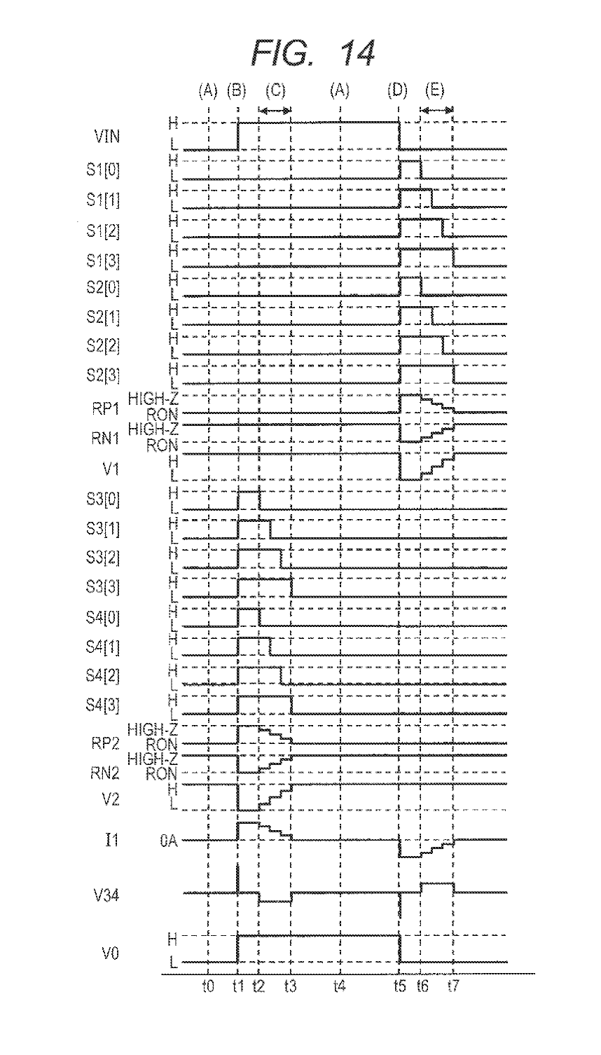

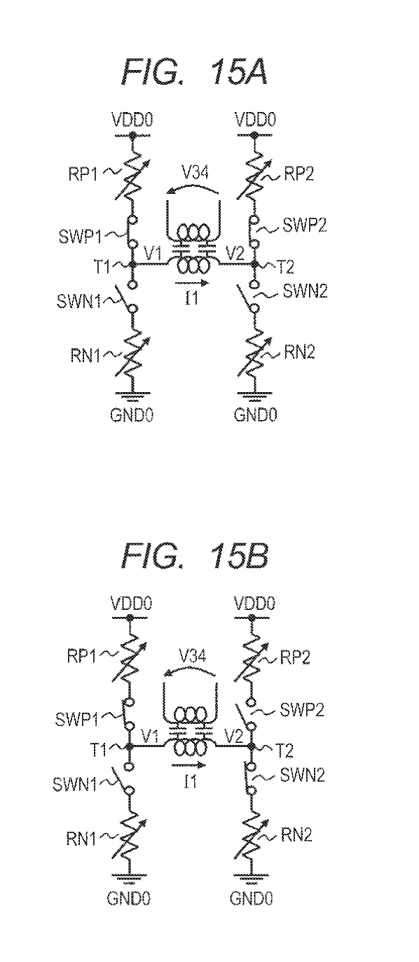

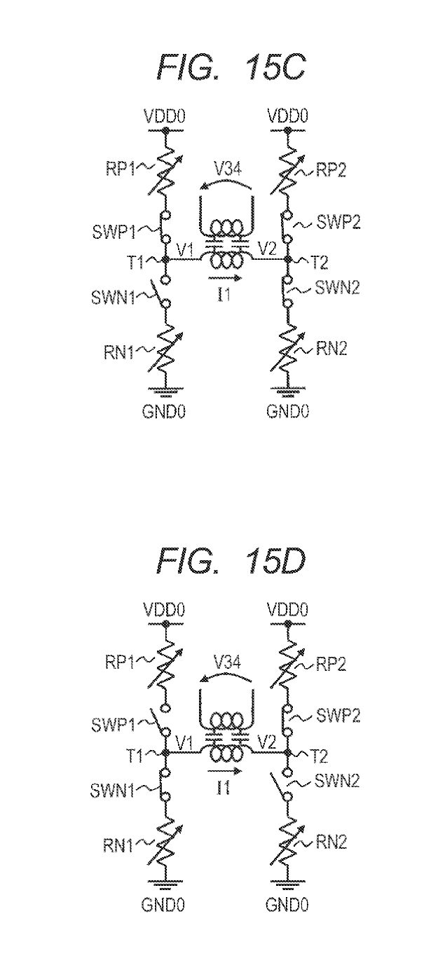

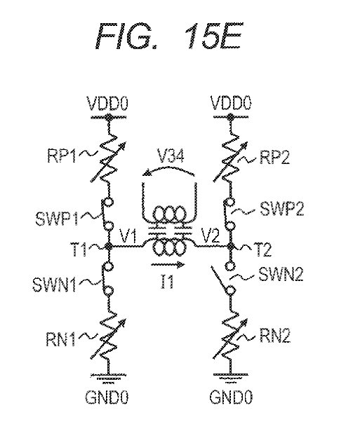

Next, with reference to FIG. 14 and FIG. 15A to FIG. 15E, an operation of the semiconductor integrated circuit 2 having the transmitter circuit Tx2 will be explained. FIG. 14 is a timing chart showing the operation of the semiconductor integrated circuit 2. FIG. 15A to FIG. 15E are diagrams each showing an equivalent circuit in each operating state of the drive circuit 22 provided in the transmitter circuit Tx1.

In FIG. 15A to FIG. 15E, the resistive element RP1 and the switching element SWP1 correspond to the transistors MP11 to MP14, the resistive element RP2 and the switching element SWP2 correspond to the transistors MP21 to MP24, the resistive element RN1 and the switching device SWN1 correspond to the transistors MN11 to MN14, and the resistive element RN2 and the switching device SWN2 correspond to the transistors MN21 to MN24. Incidentally, the resistive element RP1 shows explicitly an impedance between the one end T1 of the primary coil L11 and the power supply voltage terminal VDD0, and the resistive element RN1 shows explicitly an impedance between the one end T1 of the primary coil L11 and the ground voltage terminal GND0, respectively. Similarly, the resistive element RP2 shows explicitly an impedance between the other end T2 of the primary coil L11 and the power supply voltage terminal VDD0, and the resistive element RN2 shows explicitly an impedance between the other end T2 of the primary coil L11 and the ground voltage terminal GND0, respectively. In the following explanation, impedance values of the resistive elements RP1, RN1, RP2, and RN2 are termed impedances RP1, RN1, RP2, and RN2, respectively.

In FIG. 14, the transmit data VIN holds the state of L level in the initial state (time t0). Since the control circuit 21 outputs the control signals S1 to S4 of L level at this time, the transistors MP11 to MP14 and MP21 to MP24 turn on, and the transistors MN11 to MN14 and MN21 to MN24 turn off (the operating state A shown in FIG. 15A). In other words, the one end T1 of the primary coil L11 is coupled with the power supply voltage terminal VDD0 with a comparatively low impedance RP1 (e.g., 10Ω), and the other end T2 of the primary coil L11 is coupled with the power supply voltage terminal VDD0 with a comparatively low impedance RP2 (e.g., 10Ω). Therefore, the current I1 does not flow through the primary coil L11. Therefore, the received signal V34 of the secondary coil L12 does not vary.

When the transmit data VIN changes from L level to H level (time t1), the control circuit 21 outputs the control signals S1, S2 of L level and the control signals S3, S4 of H level. Thereby, the transistors MP11 to MP14 and MN21 to MN24 turn on, and the transistors MN11 to MN14 and MP21 to MP24 turn off (the operating state B shown in FIG. 15B). In other words, the one end T1 of the primary coil L11 is coupled with the power supply voltage terminal VDD0 with a comparatively low impedance RP1, and the other end T2 of the primary coil L11 is coupled with the ground voltage terminal GND0 with a comparatively low impedance RN2 (e.g., 10Ω). Therefore, the current I1 (the first current) flows toward the other end T2 from the one end T1 of the primary coil L11. Thereby, in the secondary coil L12, the pulse signal of the positive amplitude according to the change of current of the primary coil L11 occurs as the received signal V34.

Subsequently, the control circuit 21 makes the control signals S3, S4 of a four-bit width change from H level to L level one bit by one bit, respectively (time t2 to t3). Thereby, the transistors MP21 to MP24 switch from OFF to ON sequentially, and the transistors MN21 to MN24 switch from ON to OFF sequentially (the operating state C shown in FIG. 15C). Thereby, the current I1 that is flowing toward the other end T2 from the one end T1 of the primary coil L11 becomes smaller stepwisely, and finally becomes zero. Therefore, the amplitude of the counter pulse of the negative amplitude that occurs in the secondary coil L12 becomes sufficiently small. Incidentally, the current whose quantity is less than usual like in this case is also called a second current (or an intermediate current)

Incidentally, during a variation period of the control signals S3, S4 (time t2 to t3), the other end T2 of the primary coil L11 is being coupled to the power supply voltage terminal VDD0 and the ground voltage terminal GND0 with a comparatively low parallel impedance (RP2·RN2)/(RP2+RN2). Therefore, even when the common mode voltage VCM varies during this variation period, the voltage variation of the primary coil L11 is controlled.

Next, when the transmit data VIN holds the state of H level (time t4), the control circuit 21 outputs the control signals S1 to S4 of L level. Thereby, the transistors MP11 to MP14 and MP21 to MP24 turn on, and the transistors MN11 to MN14 and MN21 to MN24 turn off (the operating state A). In other words, the one end T1 of the primary coil L11 is coupled with the power supply voltage terminal VDD0 with a comparatively low impedance RP1, and the other end T2 of the primary coil L11 is coupled with the power supply voltage terminal VDD0 with a comparatively low impedance RP2 (e.g., 10Ω). Therefore, the current I1 does not flow through the primary coil L11. Accordingly, the received signal V34 of the secondary coil L12 does not vary.

When the transmit data VIN changes from H level to L level (time t5), the control circuit 21 outputs the control signals S1, S2 of H level and the control signals S3, S4 of L level. Thereby, the transistors MP11 to MP14 and MN21 to MN24 turn off, and the transistors MN11 to MN14 and MP21 to MP24 turn on (an operating state D shown in FIG. 15D). In other words, the one end T1 of the primary coil L11 is coupled with the ground voltage terminal GND0 with a comparatively low impedance RN1 (e.g., 10Ω), and the other end T2 of the primary coil L11 is coupled with the power supply voltage terminal VDD0 with a comparatively low impedance RP2. Therefore, the current I1 flows toward the one end T1 from the other end T2 of the primary coil L11. Thereby, the pulse signal of the negative amplitude according to the change of current of the primary coil L11 occurs in the secondary coil L12 as the received signal V34.

Subsequently, the control circuit 21 makes the control signals S1, S2 of a four-bit width change from H level to L level one bit by one bit, respectively (time t6 to t7). Thereby, the transistors MP11 to MP14 switch from OFF to ON sequentially, and the transistors MN11 to MN14 switch from ON to OFF sequentially (an operating state E shown in FIG. 15E). Thereby, the current I1 that is flowing toward the one end T1 from the other end T2 of the primary coil L11 becomes smaller stepwisely, and finally becomes zero. Therefore, the amplitude of the counter pulse of the positive amplitude that occurs in the secondary coil L12 becomes sufficiently small.

Incidentally, during the variation period of the control signals S1, S2 (time t6 to t7), the one end T1 of the primary coil L11 is coupled to the power supply voltage terminal VDD0 and the ground voltage terminal GND0 with a comparatively low parallel impedance (RP·RN1)/(RP1+RN1). Therefore, even when the common mode voltage VCM varies during this variation period, the voltage variation of the primary coil L11 is controlled.

The receiver circuit Rx1 raises the output data VO in synchronization with the pulse signal of the positive amplitude that occurs in the secondary coil L12 (time t1), and falls the output data VO in synchronization with the pulse signal of the negative amplitude that occurs in the secondary coil L12 (time t5).

Thus, the transmitter circuit Tx1 according to this embodiment makes sufficiently small the amplitude of the counter pulse that occurs in the secondary coil L12 by making the current flowing through the primary coil L11 smaller stepwisely and finally stopping it. Thereby, even if the receiver circuit Rx1 is of a general configuration that does not eliminate the counter pulse, highly accurate (malfunction avoiding) signal transfer is possible. Furthermore, the transmitter circuit Tx2 according to this embodiment is maintaining the parallel impedance between the both ends T1, T21 of the primary coil L11 and the power supply voltage terminal VDD0 and the ground voltage terminal GND0 to be a comparatively low value (at least a value lower than the direct-current resistance (about 100Ω) of the coil, e.g., 20Ω or less) during a period when any of the control signals S1 to S4 is varying stepwisely. Thereby, even when the common mode voltage VCM varies during the variation period of the control signal, the transmitter circuit Tx2 according to this embodiment is capable of transferring a signal accurately (performing malfunction avoiding signal transfer) by controlling the voltage variation of the primary coil L11. In this embodiment, it becomes possible to suppress the influence of noises resulting from the VCM variation and also to suppress the counter pulse, which enables the signal transfer that avoids the malfunction.

Incidentally, in this embodiment, a case of a four stage configuration that had the four p-channel MOS transistors (MP11 to MP14) and the four n-channel MOS transistors (MN11 to MN14) coupled to the terminal T1, and the four p-channel MOS transistors (MP21 to MP24) and the four n-channel MOS transistors (MN21 to MN24) coupled to the terminal T2 was shown (for example, a driving ability in total of the p-channel MOS transistors coupled to the terminal T1 can be switched to any of four stages). However, the present invention is not limited to this embodiment, and the embodiment can be modified appropriately into a configuration where two or more transistors are provided. Moreover, the above-mentioned parallel impedance does not always need to be constant, and should just be maintained at least at a value lower than the direct-current resistance of the coil.

### Fourth Embodiment

A transmitter circuit Tx2 according to this embodiment enlarges further the amplitude of the pulse signal that is made to occur in the secondary coil L12 by changing the timing of ON/OFF of each transistor as compared with the case of the third embodiment. Thereby, it becomes possible to perform still highly accurate (malfunction avoiding) signal transfer. Since a configuration of the transmitter circuit Tx2 according to this embodiment and a configuration of the semiconductor integrated circuit 2 having it are the same as those of the third embodiment, the same reference symbol is given to each of the components and its overlapped explanation is omitted.

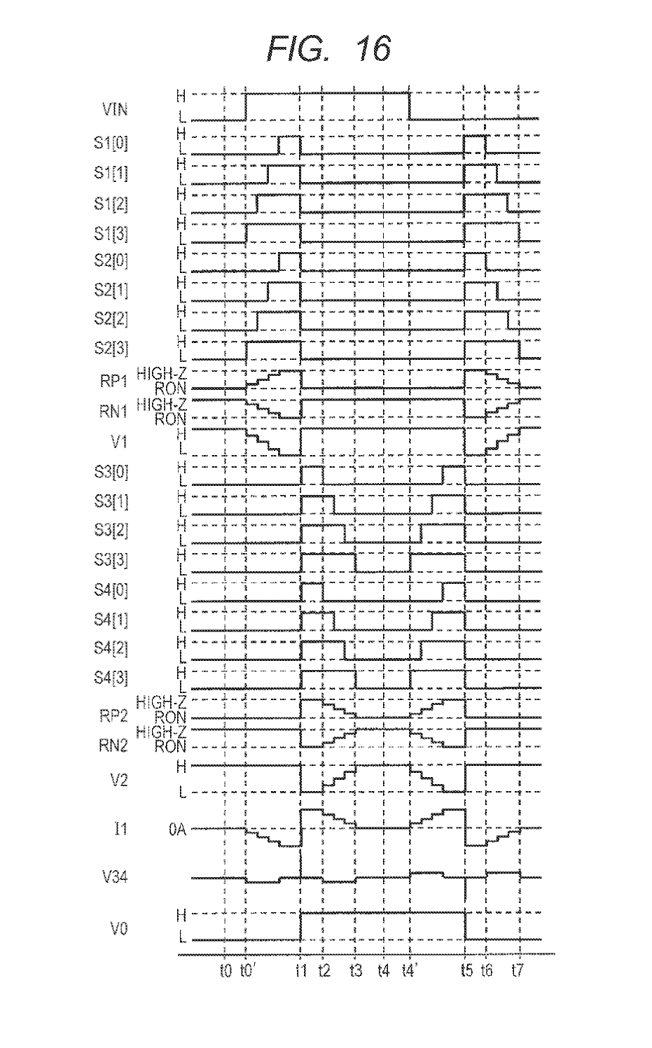

FIG. 16 is a timing chart showing an operation of the semiconductor integrated circuit 2 according to this embodiment. Below, only contents different from those of the timing chart shown in FIG. 14 will be explained.

For example, when the transmit data VIN changes from L level to H level (time t0′), the control circuit 21 makes the control signals S1, S2 of the four-bit width change from L level to H level one bit by one bit, respectively (time t0′ to t1). Thereby, the transistors MP11 to MP14 switch from ON to OFF sequentially, and the transistors MN11 to MN14 switch from OFF to ON sequentially. Thereby, the current I1 begins to flow gradually toward the one end T1 from the other end T2 of the primary coil L11.

Incidentally, during the variation period of the control signals S1, S2 (times t0′ to t1), the one end T1 of the primary coil L11 is coupled to the power supply voltage terminal VDD0 and the ground voltage terminal GND0 with a comparatively low parallel impedance (RP1·RN1)/(RP1+RN1). Therefore, even when the common mode voltage VCM varies during this variation period, the voltage variation of the primary coil L11 is controlled.

When all of the transistors MP11 to MP14 turn off and all of the transistors MN11 to MN14 turn on, the control circuit 21 makes the control signals S1, S2 change from H level to L level all at once, and makes the control signals S3, S4 change from L level to H level all at once (time t1). Thereby, the transistors MP11 to MP14 and MN21 to MN24 turn on, and the transistors MN11 to MN14 and MP21 to MP24 turn off. Therefore, the current I1 begins to flow toward the other end T2 from the one end T1 of the primary coil L11 in a direction opposite to a previous direction. That is, the current I1 flowing through the primary coil L11 varies largely. Incidentally, the change of current (dI1/dt) at this time is about two times as large as that of the case of FIG. 14. Thereby, the pulse signal of the positive amplitude having a large amplitude occurs in the secondary coil L12 as the received signal V34.

Since operations at times t1 to t4 are the same as those at times t1 to t4 of FIG. 14, their explanations are omitted.

On the other hand, when the transmit data VIN changes from H level to L level (time t4′), the control circuit 21 makes the control signals S3, S4 of the four-bit width change from L level to H level one bit by one bit (time t4′ to t5), respectively. Thereby, the transistors MP21 to MP24 switch from ON to OFF sequentially, and the transistors MN21 to MN24 switch from OFF to ON sequentially. Thereby, a current begins to flow gradually toward the other end T2 from the one end T1 of the primary coil L11.

Incidentally, during the variation period of the control signals S3, S4 (time t4′ to t5), the other end T2 of the primary coil L11 is being coupled to the power supply voltage terminal VDD0 and the ground voltage terminal GND0 with a comparatively low parallel impedance (RP2·RN2)/(RP2+RN2). Therefore, even when the common mode voltage VCM varies during this variation period, the voltage variation of the primary coil L11 is controlled.

When all of the transistors MP21 to MP24 turn off and all of the transistors MN21 to MN24 turn on, the control circuit 21 changes the control signals S3, S4 from H level to L level all at once, and changes the control signals S1, S2 from L level to H level all at once (time t5). Thereby, the transistors MP11 to MP14 and MN21 to MN24 turn off, and the transistors MN11 to MN14, MP21 to MP24 turn on. Therefore, the current I1 begins to flow toward the one end T1 from the other end T2 of the primary coil L11 in the direction opposite to the previous direction. That is, the current I1 flowing through the primary coil L11 varies largely. Incidentally, the change of current (dI1/dt) at this time is about twice as compared with the case of FIG. 14. Thereby, the pulse signal of the positive amplitude having a large amplitude occurs in the secondary coil L12 as the received signal V34.

Since the operations in time t5 to t7 are the same as those of time t5 to t7 of FIG. 14, their explanations are omitted.

Thus, the transmitter circuit Tx2 according to this embodiment is capable of transferring a signal further accurately (performing malfunction avoiding signal transfer) by enlarging the amplitude of the pulse signal that is made to generate in the secondary coil L12.

Incidentally, although this embodiment was explained in the case where the four stage transistors were provided as the example, an embodiment is not limited to this and its configuration can be modified appropriately to a configuration where two-stage or more stage transistors are provided. Moreover, the above-mentioned parallel impedance does not always need to be constant and should just be maintained at a comparatively low value.

### Fifth Embodiment

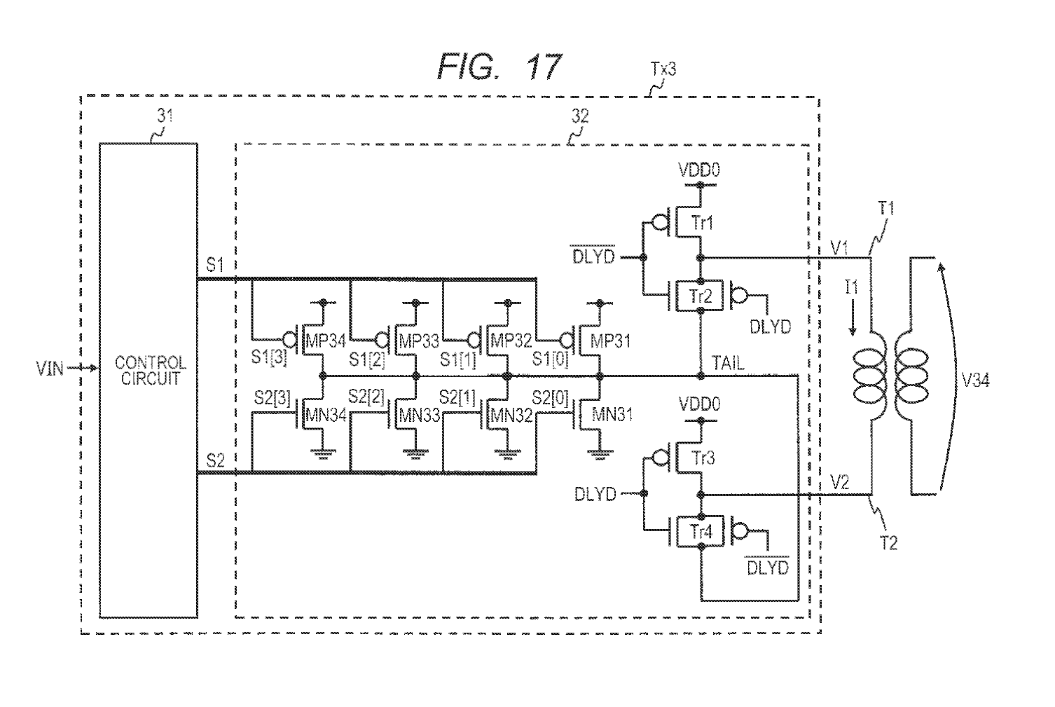

FIG. 17 is a diagram showing a configuration example of a transmitter circuit according to a fifth embodiment. Unlike the case of the third embodiment, in a transmitter circuit Tx3 shown in FIG. 17, a transistor used on the one end T1 side of the primary coil L11 and a transistor used on the other end T2 side are shared by a common transistor. Hereinafter, the embodiment will be explained specifically.

Incidentally, the transmitter circuit Tx3 corresponds to the transmitter circuit Tx2. Moreover, a semiconductor integrated circuit 3 having the transmitter circuit Tx3 corresponds to the semiconductor integrated circuit 2.

The transmitter circuit Tx3 shown in FIG. 17 has a control circuit 31 and a drive circuit 32. The drive circuit 32 has p-channel MOS transistors (hereinafter, simply termed transistors) MP31 to MP34, Tr1, and Tr3, n-channel MOS transistors (hereinafter, simply termed transistors) MN31 to MN34, and transmission gates Tr2, Tr4 each comprised of a p-channel MOS transistor and an n-channel MOS transistor. Incidentally, the Tr1 to Tr4 form a variation unit that switches coupling paths between the both ends T1, T2 of the primary coil L11, the power supply voltage terminal VDD0, and a node (a first node) TAIL.

In each of the transistors MP31 to MP34, its source is coupled to the power supply voltage terminal VDD0, its drain is coupled to the node TAIL, and its gate is supplied with the control signal S1 from the control circuit 31, respectively. More specifically, the control signals S1[0] to S1[3] are supplied to the gates of the transistors MP31 to MP34, respectively. In each of the transistors MN31 to MN34, its source is coupled to the ground voltage terminal GND0, its drain is coupled to the node TAIL, and its gate is supplied with the control signal S2 from the control circuit 31, respectively. More specifically, the control signals S2[0] to S2[3] are supplied to the gates of the transistors MN31 to MN34, respectively.

In the transistor Tr1, its source is coupled to the power supply voltage terminal VDD0, its drain is coupled to the one end T1 of the primary coil L11, and its gate is supplied with an inversion signal of a switching signal DLYD. In the transmission gate Tr2, its first terminal is coupled to the node TAIL, its second terminal is coupled to the one end T1 of the primary coil L11, its gate on the NMOS side is supplied with the inversion signal of the switching signal DLYD, and its gate on the PMOS side is supplied with the switching signal DLYD.

In the transistor Tr3, its source is coupled to the power supply voltage terminal VDD0, its drain is coupled to the other end T2 of the primary coil L11, and its gate is supplied with the switching signal DLYD. In the transmission gate Tr4, its first terminal is coupled to the node TAIL, its second terminal is coupled to the other end T2 of the primary coil L11, its gate on the NMOS side is supplied with the switching signal DLYD, and its gate on the PMOS side is supplied with the inversion signal of the switching signal DLYD.

Incidentally, even when a potential of the node TAIL rises up to around the power supply voltage VDD0, the use of the transmission gates Tr2, Tr4 enables conduction states between the node TAIL and the one end of the primary coil L11 and between the node TAIL and the other end T2 to be maintained, respectively.

The control circuit 31 generates the control signals S1, S2 for controlling ON/OFF of the transistors MP31 to MP34 and MN31 to MN34 based on the transmit data VIN, respectively. Furthermore, the control circuit 31 outputs the switching signal DLYD according to the transmit data VIN. For example, the control circuit 31 outputs the switching signal DLYD of L level when the transmit data VIN is L level, and outputs the switching signal DLYD of H level when the transmit data VIN is H level.

Since other configurations and operations of the semiconductor integrated circuit 3 are the same as those of the semiconductor integrated circuit 2, the same reference symbol is given to each of the components and its overlapped explanation is omitted.

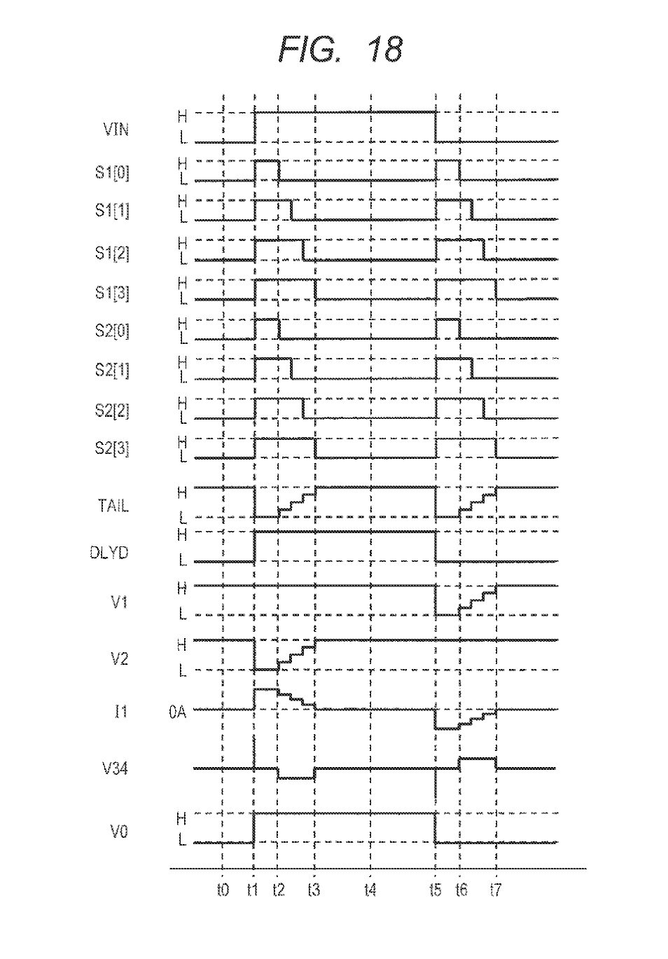

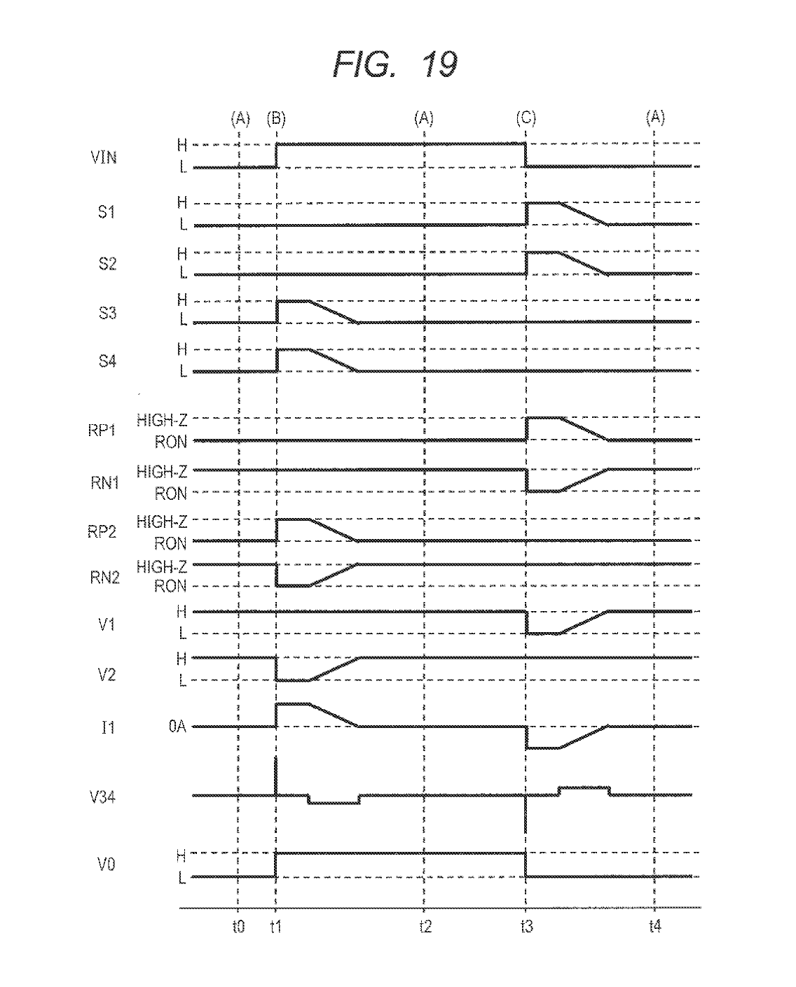

Next, with reference to FIG. 18, an operation of the semiconductor integrated circuit 3 having the transmitter circuit Tx3 will be explained. FIG. 18 is a timing chart showing the operation of the semiconductor integrated circuit 3. Incidentally, below, only contents different from those of the timing chart shown in FIG. 14 will be explained.

For example, when the transmit data VIN is L level, the control circuit 31 outputs the switching signal DLYD of L level. Thereby, the transistor Tr1 and the transmission gate Tr4 turn off, and the transmission gate Tr2 and the transistor Tr3 turn on. That is, the one end T1 of the primary coil L11 and the node TAIL establish conduction through the transmission gate Tr2, and the other end T2 of the primary coil L11 and the power supply voltage terminal VDD0 establish conduction through the transistor Tr3. At this time, the transistors MP31 to MP34 and MN31 to MN34 perform the same works as those of the transistors MP11 to MP14 and MN11 to MN14 shown in FIG. 13, respectively.

On the other hand, when the transmit data VIN is H level, the control circuit 31 outputs the switching signal DLYD of H level. Thereby, the transistor Tr1 and the transmission gate Tr4 turn on and the transmission gate Tr2 and the transistor Tr3 turn off. That is, the one end T1 of the primary coil L11 and the power supply voltage terminal VDD0 establish conduction through the transistor Tr1, and the other end T2 of the primary coil L11 and the node TAIL establish conduction through the transmission gate Tr4. At this time, the transistors MP31 to MP34 and MN31 to MN34 perform the same works as those of the transistors MP21 to MP24 and MN21 to MN24 shown in FIG. 13.

When the transmit data VIN is L level, the control signals S1, S2 are used as the control signals S1, S2 in FIG. 13, respectively; when the transmit data VIN is H level, they are used as the control signals S3, S4 in FIG. 13, respectively.

Since other operations of the timing chart shown in FIG. 18 are the same as those of the timing chart shown in FIG. 14, their explanations are omitted.

Thus, the transmitter circuit Tx3 according to this embodiment can produce an equivalent effect as that of the third embodiment. Furthermore, since the transmitter circuit Tx3 according to this embodiment can lessen the number of the transistors in the drive circuit, it is capable of controlling increase of a circuit scale. Incidentally, the transmitter circuit Tx3 according to this embodiment can also produce an effect equivalent to that of the fourth embodiment by modifying the timings of ON/OFF of the transistors.

### Sixth Embodiment

The transmitter circuit Tx1 according to this embodiment makes sufficiently small the amplitude of the counter pulse that occurs in the secondary coil L12 by cutting off gently the current I1 flowing through the primary coil L11. Even if the receiver circuit Rx1 is of a general configuration that does not eliminate the counter pulse, it is capable of performing a highly accurate (malfunction avoiding) signal transfer. Since the configuration of the transmitter circuit Tx1 according to this embodiment and the configuration of the semiconductor integrated circuit 1 having it are the same as those of the first embodiment, the same reference symbol is given to each of the components and its overlapped explanation is omitted.

FIG. 19 is a timing chart showing an operation of the semiconductor integrated circuit 1 according to this embodiment. Below, only contents different from those of the timing chart shown in FIG. 3 will be explained.

For example, when the transmit data VIN changes from L level to H level (time t1), the control circuit 11 outputs the control signals S1, S2 of L level and the control signals S3, S4 of H level. Thereby, the transistors MP11, MN21 turn on and the transistors MN11, MP21 turn off. Therefore, the current I1 flows toward the other end T2 from the one end T1 of the primary coil L11. Thereby, the pulse signal of the positive amplitude according to the change of current of the primary coil L11 occurs in the secondary coil L12 as the received signal V34.

Subsequently, the control circuit 11 makes the control signals S3, S4 change from H level to L level gently. Thereby, the transistor MP21 switches from OFF to ON gently, and the transistor MN21 switches from ON to OFF gently. Thereby, the current I1 that is flowing toward the other end T2 from the one end T1 of the primary coil L11 becomes small gently, and finally becomes zero. Therefore, the amplitude of the counter pulse of the negative amplitude that occurs in the secondary coil L12 becomes sufficiently small.

Incidentally, during the variation period of the control signals S3, S4, the other end T2 of the primary coil L11 is coupled to the power supply voltage terminal VDD0 and the ground voltage terminal GND0 with the comparatively low parallel impedance (RP2·RN2)/(RP2+RN2). Therefore, even when the common mode voltage VCM varies during this variation period, the voltage variation of the primary coil L11 is controlled.

On the other hand, when the transmit data VIN changes from H level to L level (time t3), the control circuit 11 outputs the control signals S1, S2 of H level and the control signals S3, S4 of L level. Thereby, the transistors MP11, MN21 turn off and the transistors MN11, MP21 turn on. Therefore, the current I1 flows toward the one end T1 from the other end T2 of the primary coil L11. Thereby, the pulse signal of the negative amplitude according to the change of current of the primary coil L11 occurs in the secondary coil L12 as the received signal V34.

Subsequently, the control circuit 11 makes the control signals S1, S2 change from H level to L level gently. Thereby, the transistor MP11 switches from OFF to ON gently, and the transistor MN11 switches from ON to OFF gently. Thereby, the current I1 that is flowing toward the one end T1 from the other end T2 of the primary coil L11 becomes smaller gently, and finally becomes zero. Therefore, the amplitude of the counter pulse of the positive amplitude that occurs in the secondary coil L12 becomes sufficiently small.

Incidentally, during the variation period of the control signals S1, S2, the one end T1 of the primary coil L11 is being coupled to the power supply voltage terminal VDD0 and the ground voltage terminal GND0 with the comparatively low parallel impedance (RP·RN1)/(RP1+RN1). Therefore, even when the common mode voltage VCM varies during this variation period, the voltage variation of the primary coil L11 is controlled.

The receiver circuit Rx1 raises the output data VO in synchronization with the pulse signal of the positive amplitude that occurs in the secondary coil L12 (time t1), and falls the output data VO in synchronization with the pulse signal of the negative amplitude that occurs in the secondary coil L12 (time t3).

Thus, the transmitter circuit Tx1 according to this embodiment makes sufficiently small the amplitude of the counter pulse that occurs in the secondary coil L12 by cutting off gently the current flowing through the primary coil L11. Therefore, even if the receiver circuit Rx1 is of a general configuration that does not eliminate the counter pulse, highly accurate (malfunction avoiding) signal transfer is possible. Furthermore, the transmitter circuit Tx1 according to this embodiment maintains parallel impedances between the both ends T1, T2 of the primary coil L11 and the power supply voltage terminal VDD0 and between the both ends T1, T2 and the ground voltage terminal GND0 at the comparatively low value (the value being at least lower than the direct-current resistance of the coil (about 100Ω), e.g., 20Ω or less) during a period when any of the control signals S1 to S4 varies gently. Thereby, the transmitter circuit Tx1 according to this embodiment is capable of performing signal transfer accurately (performing malfunction avoiding signal transfer) by controlling the voltage variation of the primary coil L11 even when the common mode voltage VCM varies during the variation period of the control signal.

### Seventh Embodiment

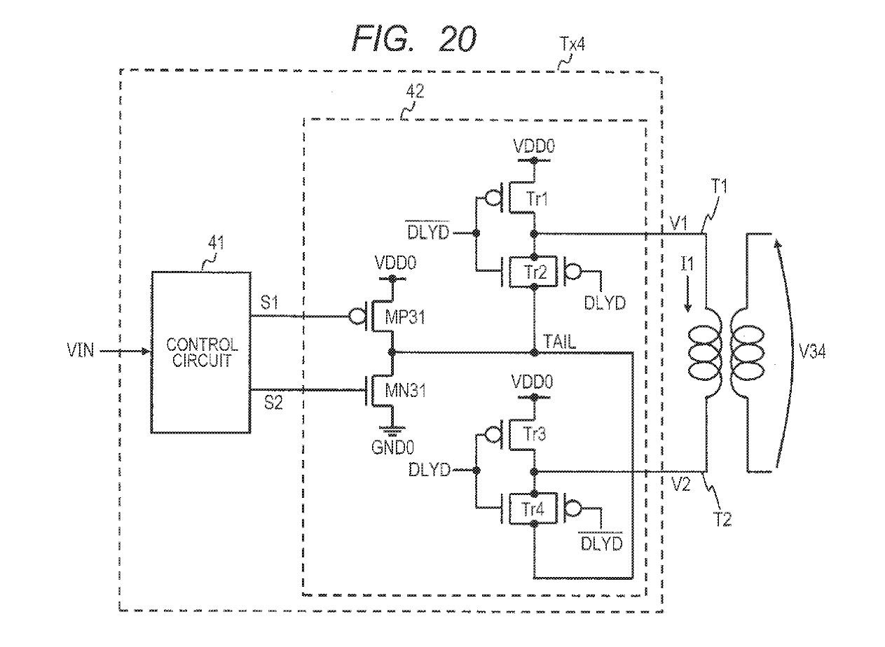

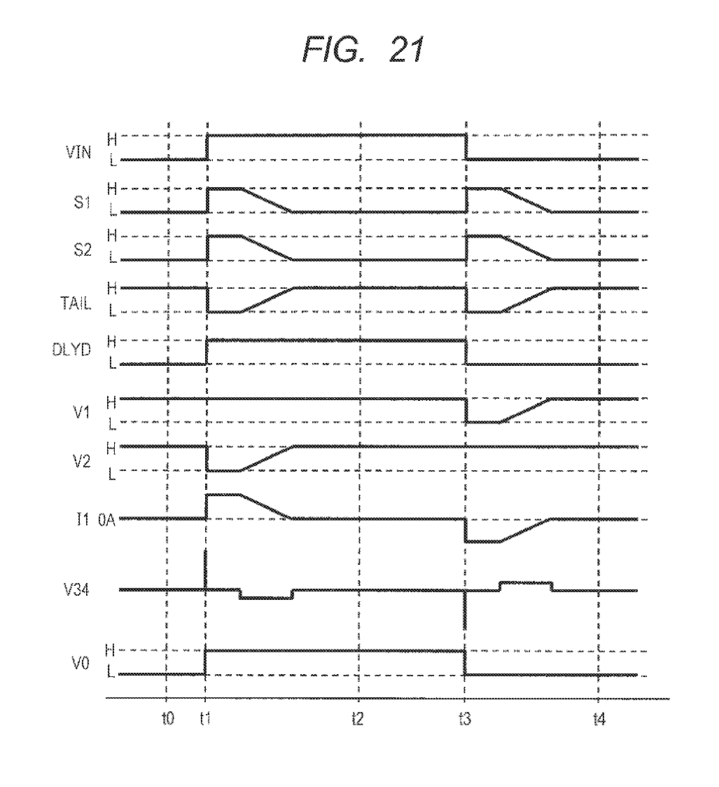

FIG. 20 is a diagram showing a configuration example of a transmitter circuit according to a seventh embodiment. Unlike the case of the sixth embodiment, in a transmitter circuit Tx4 shown in FIG. 20, the transistor used on the one end T1 side of the primary coil L11 and the transistor used on the other end T2 side are shared by a common transistor. Hereinafter, it will be explained specifically.

Incidentally, the transmitter circuit Tx4 corresponds to the transmitter circuit Tx1. Moreover, a semiconductor integrated circuit 4 having the transmitter circuit Tx4 corresponds to the semiconductor integrated circuit 1.

The transmitter circuit Tx4 shown in FIG. 20 has a control circuit 41 and a drive circuit 42. The drive circuit 42 has p-channel MOS transistors (hereinafter, simply termed transistors) MP31, Tr1, and Tr3, and an n-channel MOS transistor (hereinafter, simply termed transistor) MN31, and the transmission gates Tr2, Tr4.

In the transistor MP31, its source is coupled to the power supply voltage terminal VDD0, its drain is coupled to the node TAIL, and its gate is supplied with the control signal S1 from the control circuit 41. In the transistor MN31, its source is coupled to the ground voltage terminal GND0, its drain is coupled to the node TAIL, and its gate is supplied with the control signal S2 from the control circuit 41.

In the transistor Tr1, its source is coupled to the power supply voltage terminal VDD0, its drain is coupled to the one end T1 of the primary coil L11, and its gate is supplied with the inversion signal of the switching signal DLYD. In the transmission gate Tr2, its first terminal is coupled to the node TAIL, its second terminal is coupled to the one end T1 of the primary coil L11, its gate on the NMOS side is supplied with the inversion signal of the switching signal DLYD, and its gate on the PMOS side is supplied with the switching signal DLYD.

In the transistor Tr3, its source is coupled to the power supply voltage terminal VDD0, its drain is coupled to the other end T2 of the primary coil L11, and its gate is supplied with the switching signal DLYD. In the transmission gate Tr4, its first terminal is coupled to the node TAIL, its second terminal is coupled to the other end T2 of the primary coil L11, its gate on the NMOS side is supplied with the switching signal DLYD, and its gate on the PMOS side is supplied with the inversion signal of the switching signal DLYD.

Incidentally, the use of the transmission gates Tr2, Tr4 enables the conduction states between the node TAIL and the one end T1 of the primary coil L11 and between the node TAIL and the other end T2 to be maintained, respectively, even when the potential of the node TAIL rises up to around the power supply voltage VDD0.

The control circuit 41 generates the control signals S1, S2 for controlling ON/OFF of the transistors MP31, MN31 based on the transmit data VIN. Furthermore, the control circuit 41 outputs the switching signal DLYD according to the transmit data VIN. For example, the control circuit 41 outputs the switching signal DLYD of L level when the transmit data VIN is L level, and outputs the switching signal DLYD of H level when the transmit data VIN is H level.

Since other configurations and operations of the semiconductor integrated circuit 4 are the same as those of the semiconductor integrated circuit 1, the same reference symbol is given to each of the components and its overlapped explanation is omitted.

Next, with reference to FIG. 21, an operation of the semiconductor integrated circuit 4 having the transmitter circuit Tx4 will be explained. FIG. 21 is a timing chart showing the operation of the semiconductor integrated circuit 4. Incidentally, below, only contents different from those of the timing chart shown in FIG. 19 will be explained.

For example, when the transmit data VIN is L level, the control circuit 41 outputs the switching signal DLYD of L level. Thereby, the transistor Tr1 and the transmission gate Tr4 turn off and the transmission gate Tr2 and the transistor Tr3 turn on. That is, the one end T1 of the primary coil L11 and the node TAIL establish conduction through the transmission gate Tr2, and the other end T2 of the primary coil L11 and the power supply voltage terminal VDD0 establish conduction through the transistor Tr3. At this time, the transistors MP31, MN31 perform the same works as those of the transistors MP11, MN11 shown in FIG. 1, respectively.

On the other hand, when the transmit data VIN is H level, the control circuit 41 outputs the switching signal DLYD of H level. Thereby, the transistor Tr1 and the transmission gate Tr4 turn on and the transmission gate Tr2 and the transistor Tr3 turn off. That is, the one end T1 of the primary coil L11 and the power supply voltage terminal VDD0 establish conduction through the transistor Tr1, and the other end T2 of the primary coil L11 and the node TAIL establish conduction through the transmission gate Tr4. At this time, the transistors MP31, MN31 perform the same works as those of the transistors MP21, MN21 shown in FIG. 1, respectively.

The control signals S1, S2 are used as the control signals S1, S2 in FIG. 1 when the transmit data VIN is L level, respectively, and they are used as the control signals S3, S4 in FIG. 1 when the transmit data VIN is H level, respectively.

Since other operations of the timing chart shown in FIG. 21 are the same as those of the timing chart shown in FIG. 19, their explanations are omitted.

Thus, the transmitter circuit Tx4 according to this embodiment is capable of producing an effect equivalent to that of the sixth embodiment.

### Eighth Embodiment

FIG. 22 is a diagram showing a configuration example of a transmitter circuit according to an eighth embodiment. A transmitter circuit Tx5 shown in FIG. 22 is different from those of the other embodiments: a direction of the current that is caused to flow through the primary coil is only one way.

More specifically, for example, the transmitter circuit Tx5 expresses a logical value of the transmit data VIN by causing a pulse current to flow consecutively through the primary coil or not causing so. Alternatively, the transmitter circuit Tx5 expresses the rise and fall of the transmit data VIN by a difference in the number of current pulses that are caused to flow through the primary coil instead of the direction of the current flowing through the primary coil.

The transmitter circuit Tx5 shown in FIG. 22 has a control circuit 51 and a drive circuit 52. The drive circuit 52 has a p-channel MOS transistor (hereinafter, simply termed transistor) MP51 and an n-channel MOS transistor (hereinafter, simply termed transistor) MN51. Incidentally, FIG. 22 shows an alternating-current coupling element ISO5 comprised of a primary coil L51 and a secondary coil L52, and a receiver circuit Rx5.

The one end T1 of the primary coil L51 is coupled to the power supply voltage terminal VDD0. In the transistor MN51, its source is coupled to the ground voltage terminal GND0, its drain is coupled to the other end T2 of the primary coil L51, and its gate is supplied with a control signal PLS from the control circuit 51. In the transistor MP51, its source is coupled to the power supply voltage terminal VDD0, its drain is coupled to the other end T2 of the primary coil L51, and its gate is supplied with a control signal IDLE from the control circuit 51.

The one end of the secondary coil L52 is coupled to a power supply voltage terminal VDD1. The receiver circuit Rx5 reproduces the transmit data VIN based on the voltage (the received signal VR) of the other end of the secondary coil L52, and outputs it as the output data VO.

In the example of FIG. 23, when the transmit data VIN is L level, the control circuit 51 outputs the control signal PLS of L level and the control signal IDLE of L level. Thereby, the transistor MN51 turns off and the transistor MP51 turns on. At this time, the other end T2 of the primary coil L51 is coupled with the power supply voltage terminal VDD0 with a comparatively low impedance. Moreover, the one end T1 of the primary coil L51 is coupled to the power supply voltage terminal VDD0. Therefore, no current flows through the primary coil L51.

On the other hand, when the transmit data VIN is H level, the control circuit 51 outputs the control signal PLS that repeats H and L levels alternately, and outputs the control signal IDLE of H level. Thereby, the transistor MN51 repeats turning on and off and the transistor MP51 turns off. Thereby, a consecutive pulse current flows through the primary coil L51.

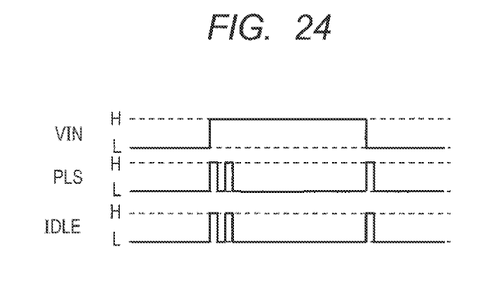

Moreover, in the example of FIG. 24, when there is no variation in the transmit data VIN, the control circuit 51 outputs the control signal PLS of L level and the control signal IDLE of L level. Thereby, the transistor MN51 turns off and the transistor MP51 turns on. At this time, the other end T2 of the primary coil L51 is coupled with the power supply voltage terminal VDD0 with a comparatively low impedance. Moreover, the one end T1 of the primary coil L51 is coupled to the power supply voltage terminal VDD0. Therefore, no current flows through the primary coil L51.

On the other hand, when the transmit data VIN varies, the control circuit 51 raises the control signal PLS once or twice, and fall the control signal IDLE once or twice. Thereby, the transistor MN51 turns on once or twice and the transistor MP51 turns off once or twice. Thereby, a pulse current flows through the primary coil L51 once or twice.

Thus, when causing no current to flow through the primary coil L51, the transmitter circuit Tx5 couples the both ends T1, T2 of the primary coil L11 and the power supply voltage terminal VDD with a comparatively low impedance by turning on the transistor MP51 and turning off the MN51. Thereby, the voltage variation of the primary coil L51 accompanying the variation of the common mode voltage VCM is controlled. That is, the transmitter circuit Tx5 according to this embodiment is capable of performing signal transfer accurately (performing malfunction avoiding signal transfer) by controlling the voltage variation of the primary coil even when the common mode voltage VCM varies.

As described above, the transmitter circuits according to the above-mentioned embodiments each couple the both ends of the primary coil and the power supply voltage VDD0 with the comparatively low impedance when causing no current to flow through the primary coil L51. Thereby, the voltage variation of the primary coil L51 accompanying the variation of the common mode voltage VCM is controlled.

Furthermore, even when causing a current that is smaller than usual (the second current) to flow through the primary coil, it couples the both ends of the primary coil and the power supply voltage VDD0 and the ground voltage terminal GND with the comparatively low impedance. Thereby, the voltage variation of the primary coil L51 accompanying the variation of the common mode voltage VCM is controlled.

### (Other Examples of Implementation States of Semiconductor Integrated Circuits 1 to 8)

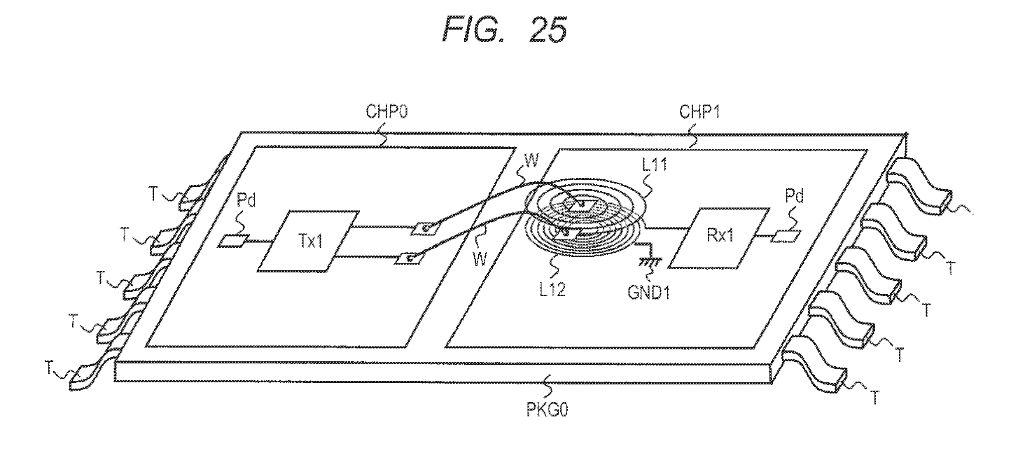

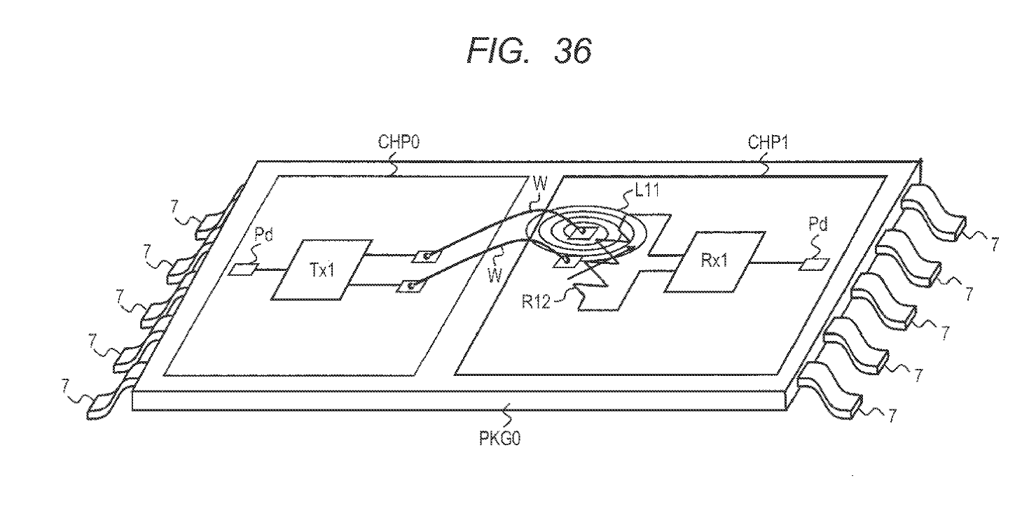

The implementation states of the semiconductor integrated circuits 1 to 8 are not limited to the implementation state shown in FIG. 2. Hereinafter, representatively, examples of other implementation states of the semiconductor integrated circuit 1 will be explained using FIG. 25 to FIG. 36. Incidentally, FIG. 25 to FIG. 35 show examples of the implementation states of cases where the transformer is used as the alternating-current coupling element ISO1, and FIG. 36 shows an example of the implementation state of a case where the GMR element is used as the alternating-current coupling element ISO1.

In the implementation state shown in FIG. 25, the transmitter circuit Tx1 is formed in the semiconductor chip CHP0; the primary coil L11 and the secondary coil L12 that are included in the alternating-current coupling element ISO1 and the receiver circuit Rx1 are formed in the semiconductor chip CHP1. Furthermore, pads coupled to outputs of the transmitter circuit Tx1 are formed in the semiconductor chip CHP0. Moreover, pads coupled to the both ends of the primary coil L11, respectively, are formed in the semiconductor chip CHP1. Then, the transmitter circuit Tx1 is coupled with the primary coil L11 formed in the semiconductor chip CHP1 through these pads and bonding wires W.

Incidentally, in the implementation state shown in FIG. 25, the primary coil L11 and the secondary coil L12 are formed over the first wiring layer and the second wiring layer that are layered in the vertical direction in one semiconductor chip, respectively.

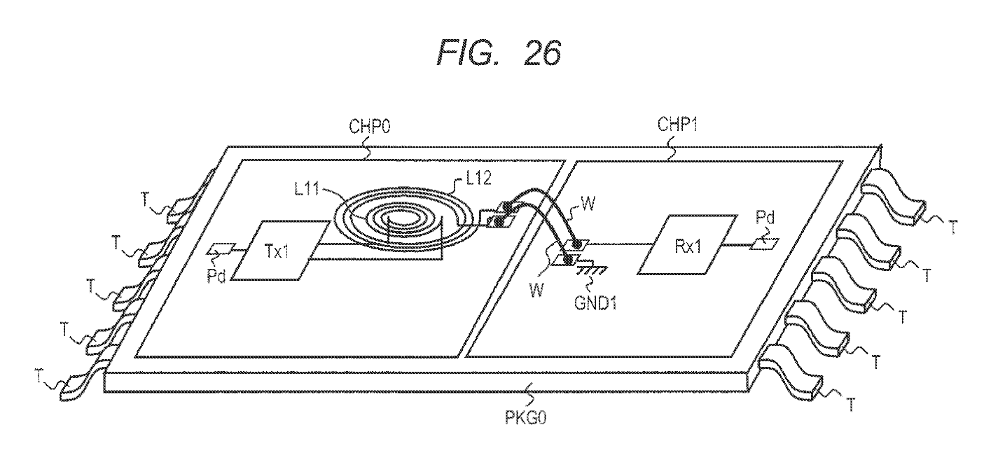

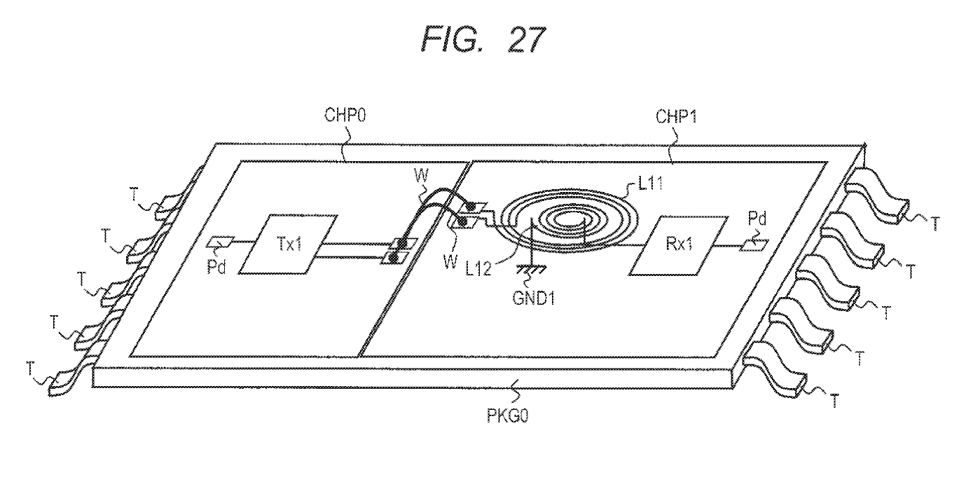

In the implementation state shown in FIG. 26, unlike FIG. 2, the primary coil L11 and the secondary coil L12 are formed over the same wiring layer. In the implementation state shown in FIG. 27, unlike FIG. 25, the primary coil L11 and the secondary coil L12 are formed over the same wiring layer.

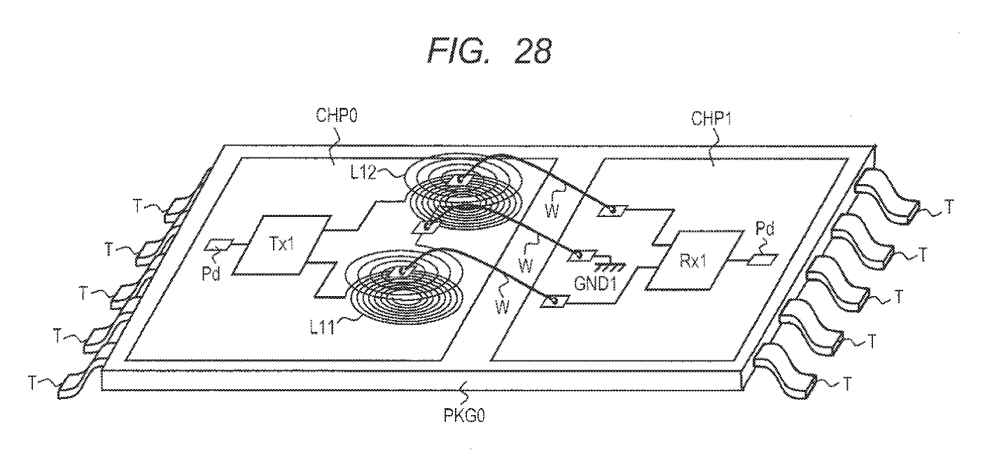

In the implementation state shown in FIG. 28, unlike FIG. 2, the primary coil L11 is formed with two pieces of winding, and the secondary coil L12 is formed with two pieces of winding between which a center tap is placed. Incidentally, the center tap of the secondary coil L12 is coupled to the ground voltage terminal GND1 on a semiconductor chip CHP1 side through the pad that was provided specially and the bonding wire W.

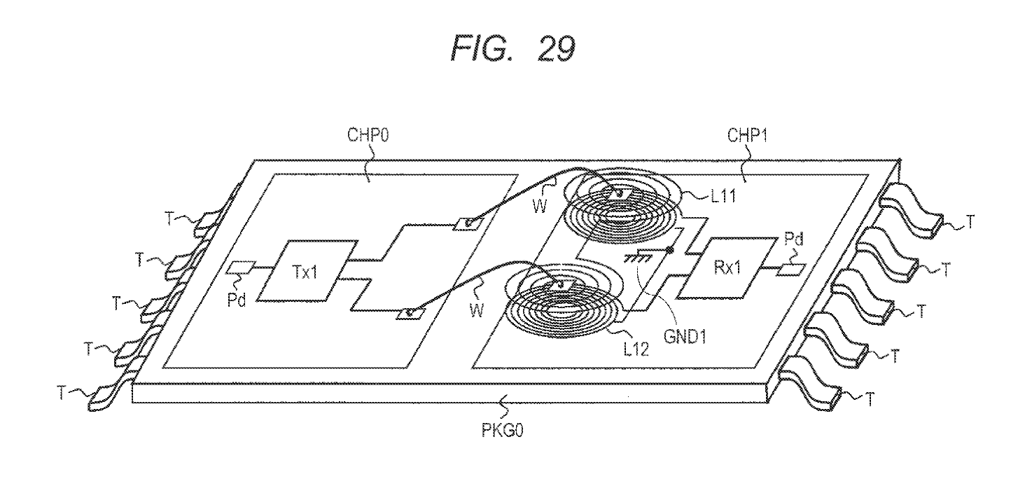

In the implementation state shown in FIG. 29, unlike FIG. 25, the primary coil L11 is formed with two pieces of winding, and the secondary coil L12 is formed with two pieces of winding between which the center tap is placed. Incidentally, the center tap of the secondary coil L12 is coupled to the ground voltage terminal GND1 on the semiconductor chip CHP1 side.

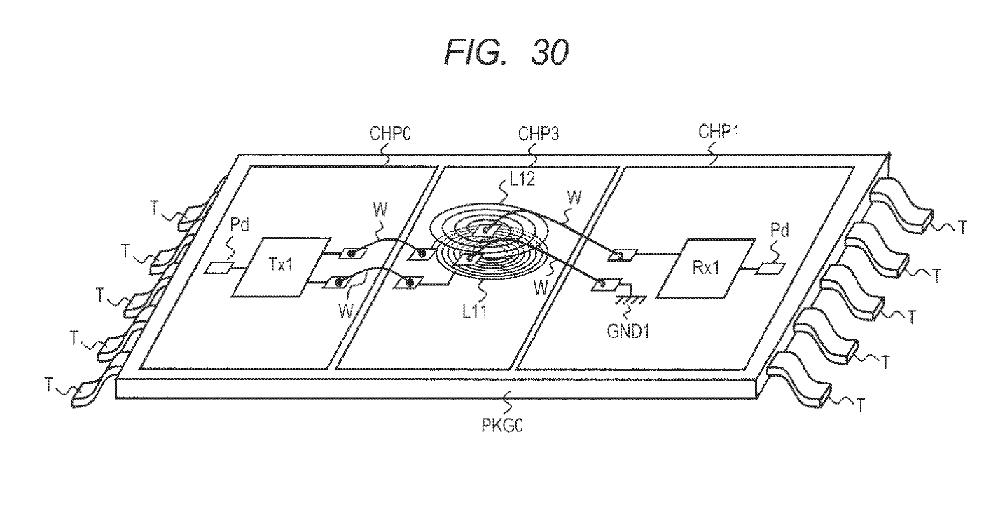

In the implementation state shown in FIG. 30, the transmitter circuit Tx1 is formed in the semiconductor chip CHP0, the receiver circuit Rx1 is formed in the semiconductor chip CHP1, and the primary coil L11 and the secondary coil L12 that are included in the alternating-current coupling element ISO1 are formed in the semiconductor chip CHP0 that is different from the semiconductor chips CHP0, CHP1. Furthermore, pads coupled to the outputs of the transmitter circuit Tx1 are formed in the semiconductor chip CHP0. A pad coupled to the input of the receiver circuit Rx1 is formed in the semiconductor chip CHP1. Moreover, in a semiconductor chip CHP3, pads coupled to the both ends of the secondary coil L12, respectively, and pads coupled to the both ends of the primary coil L11, respectively, are formed. Then, the transmitter circuit Tx1 is coupled with the primary coil L11 formed in the semiconductor chip CHP3 through these pads and bonding wires W. Moreover, the receiver circuit Rx1 is coupled with the secondary coil L12 formed in the semiconductor chip CHP3 through these pads and bonding wires W.

Incidentally, in the implementation state shown in FIG. 30, the primary coil L11 and the secondary coil L12 are formed over the first wiring layer and the second wiring layer that are layered in the vertical direction in one semiconductor chip, respectively.

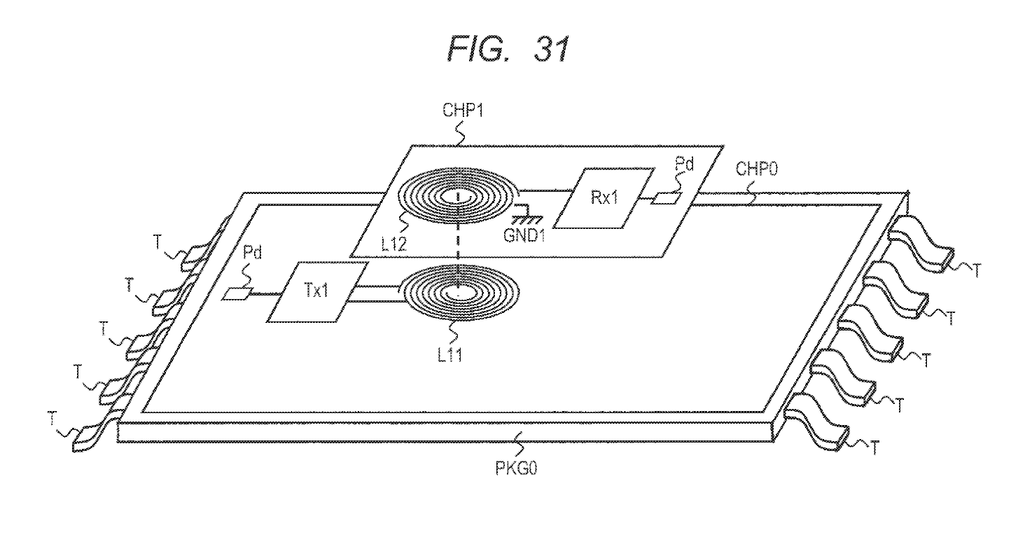

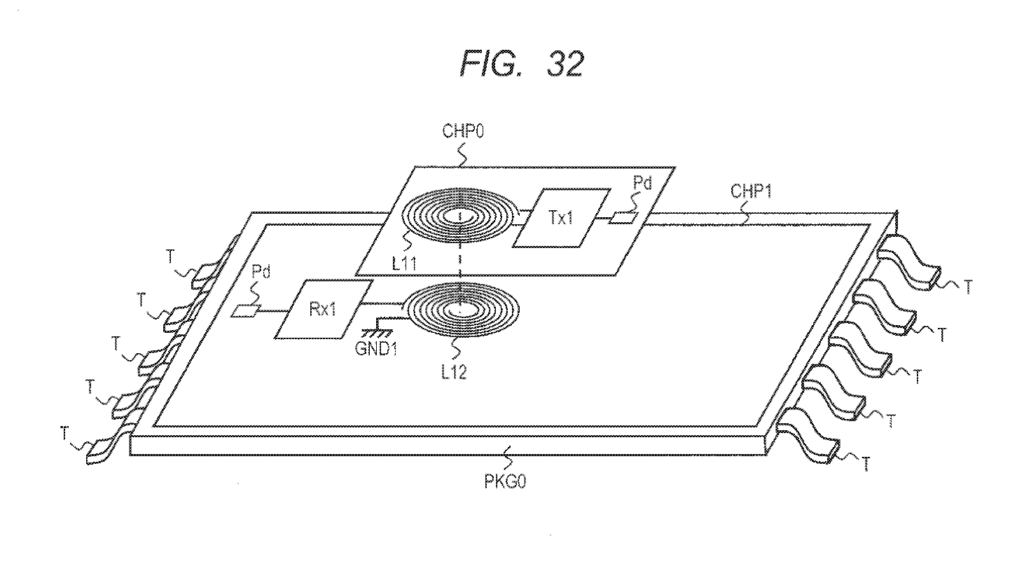

In the implementation state shown in FIG. 31 and FIG. 32, the transmitter circuit Tx1 and the primary coil L11 are formed in the semiconductor chip CHP0, the receiver circuit Rx1 and the secondary coil L12 are formed in the semiconductor chip CHP1, and in the state where the semiconductor chip CHP0 and the semiconductor chip CHP1 are stacked, the primary coil L11 and the secondary coil L12 are arranged so that their center positions may be on a straight line.

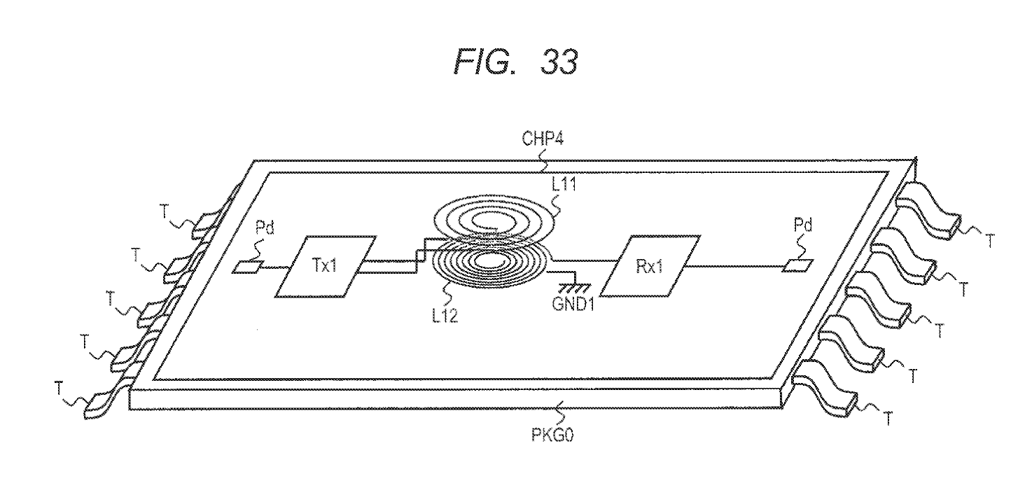

In the implementation state shown in FIG. 33, the transmitter circuit Tx1, the receiver circuit Rx1, and the primary coil L11 and the secondary coil L12 that are included in the alternating-current coupling element ISO1 are formed over a common semiconductor chip CHP4. In the example of FIG. 33, the primary coil L11 and the secondary coil L12 are formed over the first wiring layer and the second wiring layer that are layered in the vertical direction on the semiconductor chip CHP4, respectively. Then, an area where the transmitter circuit Tx1 is arranged and an area where the receiver circuit Rx1 is arranged are mutually insulated by an insulating layer formed in the substrate of the semiconductor chip CHP4.

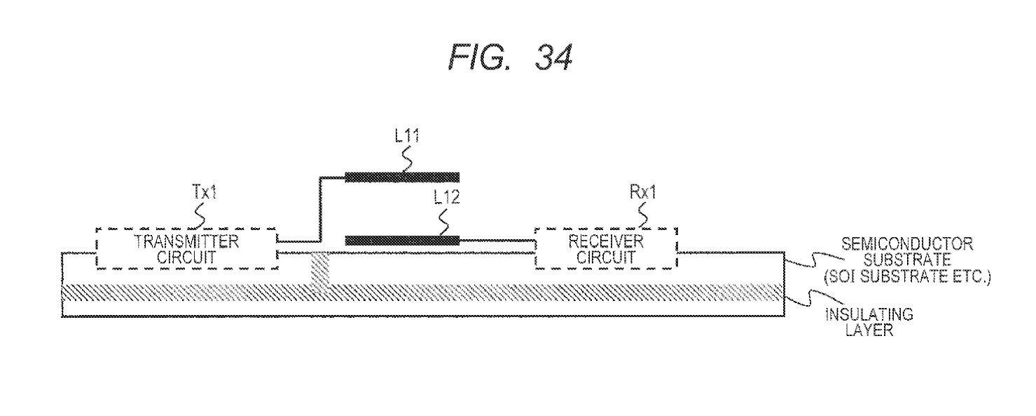

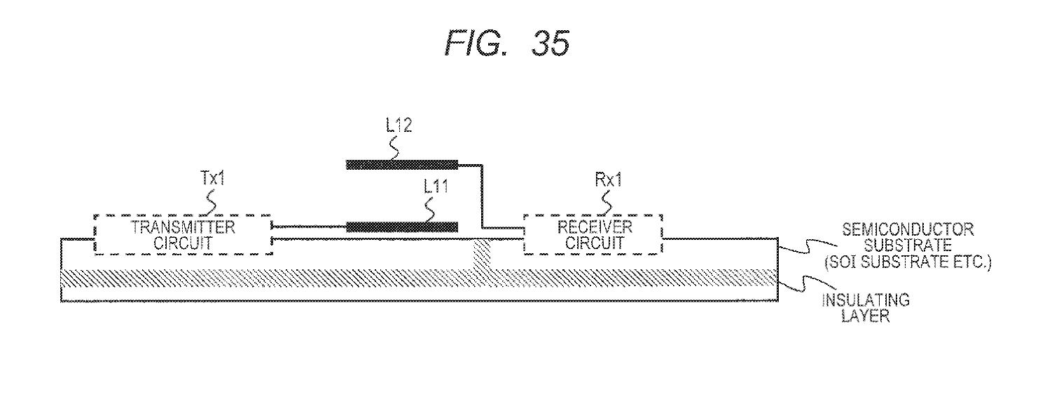

FIG. 34 and FIG. 35 are sectional views of a substrate of the semiconductor chip CHP4 shown in FIG. 33. In the example shown in FIG. 34, an area where the transmitter circuit Tx1 is formed and an area where the receiver circuit Rx1 is formed are electrically divided by the insulating layer. Then, the primary coil L11 and the secondary coil L12 are formed in the area where the receiver circuit Rx1 is formed. On the other hand, in the example shown in FIG. 35, an area where the transmitter circuit Tx1 is formed and an area where the receiver circuit Rx1 is formed are electrically divided by an insulating layer. Then, the primary coil L11 and the secondary coil L12 are formed in the area where the transmitter circuit Tx1 is formed.

In FIG. 36, the transformer used as the alternating-current coupling element ISO1 is replaced with the GMR element. More specifically, the primary coil L11 is left as it is and the secondary coil L12 is replaced with a GMR element R12.

As described above, the kind of the alternating-current coupling element ISO1 and an arrangement of the alternating-current coupling element ISO1 can be modified appropriately within a limit that does not deviate from a gist of the present invention. Incidentally, here the case where the alternating-current coupling element ISO1 was formed over the semiconductor chip was explained as the example, but it is not limited to this. The alternating-current coupling element ISO1 may be provided as an external part.

### (Application Example to Product)

A control object of the semiconductor integrated circuit according to the above-mentioned embodiments 1 to 8 is a power transistor, for example. In this case, the semiconductor integrated circuits according to the above-mentioned embodiments 1 to 8 each control a conduction state between the power supply and a load by controlling On/OFF of the power transistor according to the data VO reproduced by the receiver circuit.

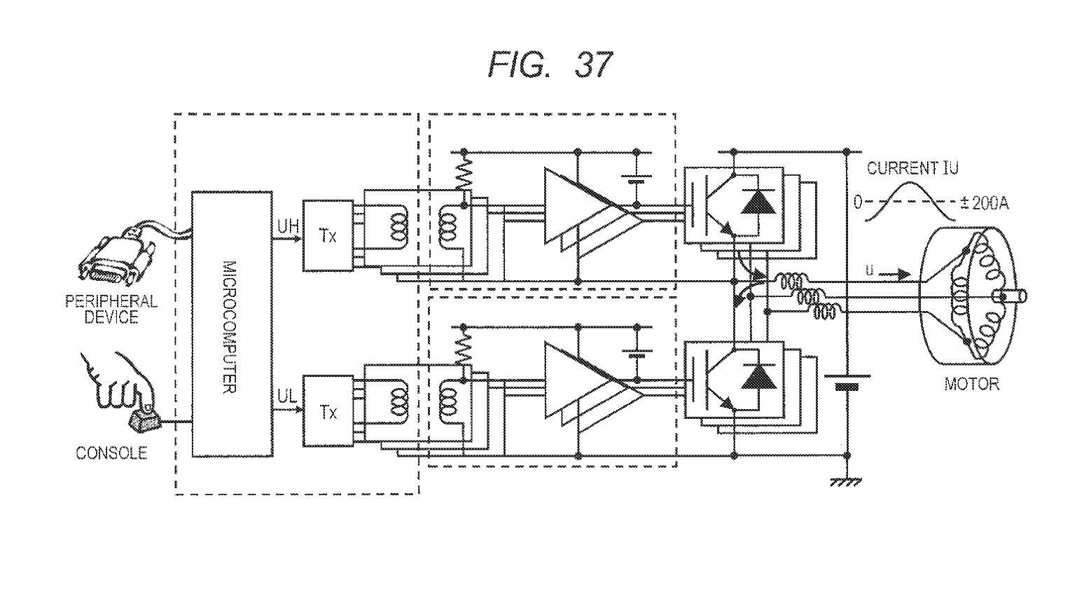

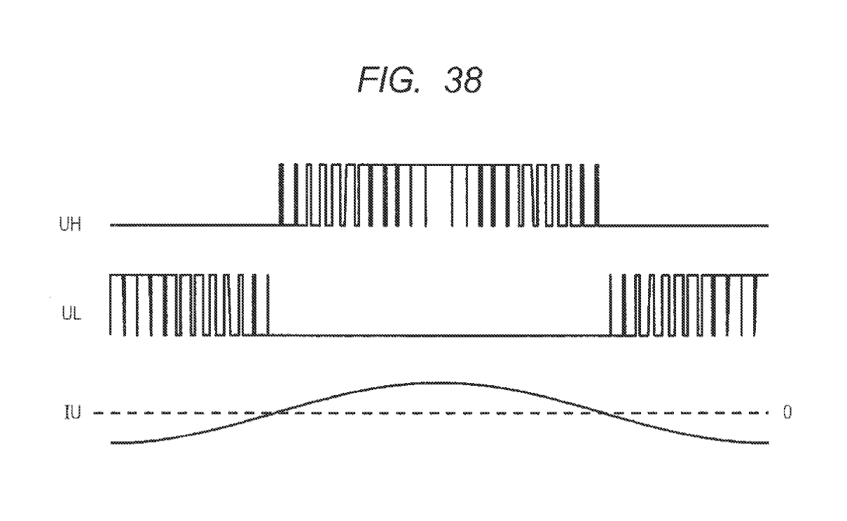

Furthermore, the semiconductor integrated circuits according to the above-mentioned embodiments 1 to 8 are applied to an inverter device for driving a motor (load) as shown in FIG. 37, for example. The inverter device shown in FIG. 37 has three gate drivers on its high side and low side, respectively, and controls a current (e.g., IU) flowing through the motor in an analog manner based on the transmit data (e.g., UH, UL) that was outputted from a microcomputer and was PWM modulated (refer to FIG. 38).

As described above, although the invention made by the present inventors was specifically explained based on the embodiments, it goes without saying that the present invention is not limited by the embodiments already described and various modifications are possible within a range that does not deviate from the gist.

In the above-mentioned embodiment, the case where, when the current was not sent through the primary coil L11, the both ends T1, T2 of the primary coil L11 and the power supply voltage terminal VDD0 were coupled together with a comparatively low impedance was explained as the example, but it is not limited to this. When causing no current to flow through the primary coil L11, the both ends T1, T2 of the primary coil L11 and the ground voltage terminal GND0 may be coupled together with a comparatively low impedance. However, in the case where the both ends T1, T2 of the primary coil L11 and the power supply voltage terminal VDD0 are coupled together, the change of current may be made larger than that in the case of coupling with the ground voltage terminal GND0 because when the current is started to flow, only the re-channel MOS transistor (e.g., the transistor MN21) needs to be switched from OFF to ON.

Some or all of the embodiments described above can be described as in the following additional remarks, but are not limited to the followings.

### (Additional Remark 1)

The embodiment is a transmitter circuit for transferring a signal to a receiver circuit insulated through an alternating-current coupling element comprised of a primary coil and a secondary coil, having a first and a second transistors that are provided between an other end of the primary coil whose one end is coupled to a first power supply and the first and a second power supplies, respectively, and a control circuit for, when causing no current to flow through the primary coil, turning on the first transistor and turning off the second transistor.

### (Additional Remark 2)

The embodiment is the transmitter circuit according to Additional Remark 1, in which when causing a first current to flow through the primary coil, the control circuit turns off the first transistor and turns on the second transistor.

### (Additional Remark 3)

The embodiment is the transmitter circuit according to Additional Remark 2, in which when causing a second current that is smaller than the first current to flow through the primary coil, the control circuit turns on the first transistor and turns on the second transistor.

### (Additional Remark 4)

The embodiment is the transmitter circuit according to Additional Remark 2 in which, when cutting off the first current flowing through the primary coil, the control circuit switches the first transistor from OFF to ON more gently than when switching it from ON to OFF, and switches the second transistor from ON to OFF more gently than when switching it from OFF to ON.

### (Additional Remark 5)

The embodiment is the transmitter circuit according to Additional Remark 1, having multiple first transistors that are parallel coupled and multiple second transistors that are parallel coupled, in which when causing no current to flow through the primary coil, the control circuit turns on the multiple first transistors and turns on the multiple second transistors.

### (Additional Remark 6)

The embodiment is the transmitter circuit according to Additional Remark 5 that, when causing the first current to flow through the primary coil, turns off the multiple first transistors and turns off the multiple second transistors.

### (Additional Remark 7)

The embodiment is the transmitter circuit according to Additional Remark 6, in which when causing a second current that is smaller than the first current to flow through the primary coil, the control circuit turns on at least one of the multiple first transistors and turns on at least one of the multiple second transistors.

### (Additional Remark 8)

The embodiment is the transmitter circuit according to Additional Remark 6, in which when cutting off the first current flowing through the primary coil, the control circuit switches the multiple first transistors from OFF to ON sequentially, and also switches the multiple second transistors from ON to OFF sequentially.

### (Additional Remark 9)

The embodiment is the transmitter circuit according to Additional Remark 1, further having the third and the fourth transistors provided between the one end of the primary coil and the first and the second power supplies, respectively, in which when causing no current to flow through the primary coil, the control circuit turns on the first and the third transistors, and turns off the second and the fourth transistors.

### (Additional Remark 10)

The embodiment is the transmitter circuit according to Additional Remark 9, in which when causing the first current to flow through the primary coil, the control circuit turns off the first and the fourth transistors, and turns on the second and the third transistors.

### (Additional Remark 11)

The embodiment is the transmitter circuit according to Additional Remark 10, in which when causing a second current that is smaller than the first current to flow through the primary coil, the control circuit turns on the first through the third transistors and turns off the fourth transistor.

### (Additional Remark 12)

The embodiment is the transmitter circuit according to Additional Remark 10, in which when cutting off the first current flowing through the primary coil, the control circuit switches the first transistor from OFF to ON more gently than when switching it from ON to OFF, and switches the second transistor from ON to OFF more gently than when switching it from OFF to ON.

### (Additional Remark 13)

The embodiment is the control circuit according to Additional Remark 9, in which when causing the first current to flow through the primary coil, the control circuit turns on the first and the fourth transistors, turns off the second and the third transistors, subsequently switches the first and the fourth transistors from ON to OFF, and switches the second and the third transistors from OFF to ON.

### (Additional Remark 14)

The embodiment is the transmitter circuit according to Additional Remark 9 that has: the multiple first transistors that are parallel coupled, the multiple second transistors that are parallel coupled, the multiple third transistors that are parallel coupled, the multiple fourth transistors that are parallel coupled, in which when causing no current to flow through the primary coil, the control circuit turns on the multiple first transistors and the multiple third transistors and turns on the multiple second transistors and the multiple fourth transistors.

### (Additional Remark 15)

The embodiment is the transmitter circuit according to Additional Remark 14, in which when causing a first current to flow through the primary coil, the control circuit turns off the multiple first transistors and the multiple fourth transistors and turns on the multiple second transistors and the multiple third transistors.

### (Additional Remark 16)

The embodiment is the transmitter circuit according Additional Remark 15, in which when causing a second current that is smaller than the first current to flow through the primary coil, the control circuit turns on the multiple third transistors, turns off the multiple fourth transistors, turns on at least one of the multiple first transistors, and turns on at least one of the multiple second transistors.

### (Additional Remark 17)

The embodiment is the transmitter circuit according Additional Remark 15, in which when cutting off the first current flowing through the primary coil, the control circuit switches the multiple first transistors from OFF to ON sequentially, and also switches the multiple second transistors from ON to OFF sequentially.

### (Additional Remark 18)

The embodiment is the transmitter circuit according to Additional Remark 14, in which when causing the first current to flow through the primary coil, the control circuit turns on the multiple first transistors and the multiple fourth transistors, turns off the multiple second transistors and the multiple third transistors, subsequently switches the multiple first transistors and the fourth transistors from ON to OFF, and switches the multiple second transistors and the multiple third transistors from OFF to ON.

### (Additional Remark 19)

The embodiment is a semiconductor integrated circuit, having: the transmitter circuit according to any one of Additional Remarks 1 to 18 that generates a pulse signal according to data supplied from the outside and outputs it as a transmitted signal; a receiver circuit for reproducing the data based on a received signal; and an alternating-current coupling element that insulates the transmitter circuit and the receiver circuit and also transfers the transmitted signal as the received signal.

### (Additional Remark 20)

The embodiment is a transmitter circuit for transmitting a signal to a receiver circuit insulated through an alternating-current coupling element comprised of a primary coil and a secondary coil, in which the transmitter circuit has a first and a second transistors that are provided between an other end of the primary coil whose one end is coupled to a first power supply and the first and a second power supplies, respectively, and a control circuit for causing an intermediate current to flow through the primary coil by turning on the first and the second transistors.

### (Additional Remark 21)

The embodiment is the transmitter circuit according to Additional Remark 9, in which when causing a third current that is opposite to the first current to flow through the primary coil, the control circuit turns on the first and the fourth transistors and turns off the second and the third transistors.

### (Additional Remark 22)

The embodiment is the transmitter circuit according to Additional Remark 2, in which when causing a second current that is smaller than the first current to flow through the primary circuit, the control circuit turns on the first transistor and turns on the second transistor so that a parallel impedance between an other end of the primary coil and the first and the second power supplies may be maintained substantially constant.

### (Additional Remark 23)

The embodiment is the transmitter circuit according to Additional Remark 6, in which when causing a second current that is smaller than the first current to flow through the primary coil, the control circuit turns on at least one of the multiple first transistors and turns on at least one of the multiple second transistors so that the parallel impedance between an other end of the primary coil and the first and the second power supplies may be maintained substantially constant.

### (Additional Remark 24)

The embodiment is the transmitter circuit according to Additional Remark 10, in which when causing a second current that is smaller than the first current to flow through the primary coil, the control circuit turns on the first through the third transistors, and turns off the fourth transistor so that a parallel impedance between an other end of the primary coil and the first and the second power supplies may be maintained substantially constant.

### (Additional Remark 25)

The embodiment is the transmitter circuit according to Additional Remark 15, in which when causing a second current that is smaller than the first current to flow through the primary coil, the control circuit turns on the multiple third transistors, turns off the multiple fourth transistors, turns on at least one of the multiple first transistors, and turns on at least one of the multiple second transistors so that a parallel impedance between an other end of the primary coil and the first and the second power supplies may be maintained substantially constant.

### (Additional Remark 26)

The embodiment is a transmitter circuit for transferring a signal to a receiver circuit insulated through an alternating-current coupling element comprised of a primary coil and a secondary coil, the transmitter circuit having: a switching unit for switching coupling paths between one and an other ends of the primary coil and a first power supply and a first node; a first and a second transistors provided between the first node and the first and a second power supplies, respectively; and a control circuit for, when causing no current to flow through the primary coil, turning on the first transistor and turning off the second transistor.

What is claimed is:

1. A transmitter circuit for transferring a signal to a receiver circuit insulated through an alternating-current coupling element comprised of a primary coil and a secondary coil, the transmitter circuit comprising:
a first and a second transistors provided between an other end of the primary coil whose one end is coupled to a first power supply and the first and a second power supplies, respectively; and
a control circuit for, when causing no current to flow through the primary coil, turning on the first transistor and turning off the second transistor.

2. The transmitter circuit according to claim 1,
wherein when causing a first current to flow through the primary coil, the control circuit turns off the first transistor and turns on the second transistor.

3. The transmitter circuit according to claim 2,
wherein when causing a second current that is smaller than the first current to flow through the primary coil, the control circuit turns on the first transistor and turns on the second transistor.

4. The transmitter circuit according to claim 2,
wherein when cutting off the first current flowing through the primary coil, the control circuit switches the first transistor from OFF to ON more gently than when switching it from ON to OFF, and switches the second transistor from ON to OFF more gently than when switching it from OFF to ON.

5. The transmitter circuit according to claim 1, comprising:
the first transistors that are parallel coupled; and
the second transistors that are parallel coupled,
wherein when causing no current to flow through the primary coil, the control circuit turns on the first transistors and turns on the second transistors.

6. The transmitter circuit according to claim 5,
wherein when causing a first current to flow through the primary coil, the control circuit turns off the first transistors, and turns on the second transistors.

7. The transmitter circuit according to claim 6,
wherein when causing a second current that is smaller than the first current to flow through the primary coil, the control circuit turns on at least one of the first transistors and turns on at least one of the second transistors.

8. The transmitter circuit according to claim 6,
wherein when cutting off the first current flowing through the primary coil, the control circuit switches the first transistors from OFF to ON sequentially and also switches the second transistors from ON to OFF sequentially.

9. The transmitter circuit according to claim 1, further comprising:
a third and a fourth transistors provided between one end of the primary coil and the first and the second power supplies, respectively,
wherein when causing no current to flow through the primary coil, the control circuit turns on the first and the third transistors and turns off the second and fourth transistors.

10. The transmitter circuit according to claim 9,
wherein when causing a first current to flow through the primary coil, the control circuit turns off the first and the fourth transistors, and turns on the second and the third transistors.

11. The transmitter circuit according to claim 10,
wherein when causing a second current that is smaller than the first current to flow through the primary coil, the control circuit turns on the first through the third transistors, and turns off the fourth transistor.

12. The transmitter circuit according to claim 10,
wherein when cutting off the first current flowing through the primary coil, the control circuit switches the first transistor from OFF to ON more gently than when switching it from ON to OFF, and switches the second transistor from ON to OFF more gently than when switching it from OFF to ON.

13. The transmitter circuit according to claim 9,
wherein when causing the first current to flow through the primary coil, the control circuit turns on the first and the fourth transistors, turns off the second and the third transistors, subsequently switches the first and the fourth transistors from ON to OFF, and switches the second and the third transistors from OFF to ON.

14. The transmitter circuit according to claim 9, comprising:
the first transistors that are parallel coupled;
the second transistors that are parallel coupled;
the third transistors that are parallel coupled; and
the fourth transistors that are parallel coupled,
wherein when causing no current to flow through the primary coil, the control circuit turns on the first transistors and the third transistors, and turns on the second transistors and the fourth transistors.

15. The transmitter circuit according to claim 14,
wherein when causing a first current to flow through the primary coil, the control circuit turns off the first transistors and the fourth transistors, and turns on the second transistors and the third transistors.

16. The transmitter circuit according to claim 15,
wherein when causing a second current that is smaller than the first current to flow through the primary coil, the control circuit turns on the third transistors, turns off the fourth transistors, turns on at least one of the first transistors, and turns on at least one of the second transistors.

17. The transmitter circuit according to claim 15,
wherein when cutting off the first current flowing through the primary coil, the control circuit switches the first transistors from OFF to ON sequentially, and also switches the second transistors from ON to OFF sequentially.

18. The transmitter circuit according to claim 14,
wherein when causing the first current to flow through the primary coil, the control circuit turns on the first transistors and the fourth transistors, turns off the second transistors and the third transistors, subsequently switches the first transistors and the fourth transistors from ON to OFF, and switches the second transistors and the third transistors from OFF to ON.

19. A semiconductor integrated circuit comprising:
the transmitter circuit according to claim 1 that generates a pulse signal according to data supplied from the outside and outputs it as a transmitted signal;
a receiver circuit for reproducing the data based on a received signal; and
an alternating-current coupling element that insulates the transmitter circuit and the receiver circuit, and also transfers the transmitted signal as the received signal.

20. A transmitter circuit that transmits a signal to a receiver circuit insulated through an alternating-current coupling element comprised of a primary coil and a secondary coil, the transmitter circuit comprising:
a first and a second transistors provided between an other end of the primary coil whose one end is connected to a first power supply and the first and a second power supplies; and
a control circuit for causing an intermediate current to flow through the primary coil by turning on the first and the second transistors.
